(19) United States
(12) Patent Application Publication
(10) Pub. No.: US 2016/0189181 A1
(43) Pub. Date: Jun. 30, 2016

(54) METHODS AND APPARATUS TO ESTIMATE DEMOGRAPHICS OF AN AUDIENCE OF A MEDIA EVENT USING SOCIAL MEDIA MESSAGE SENTIMENT

(71) Applicant: The Nielsen Company (US), LLC, Schaumburg, IL (US)

(72) Inventors: Caroline Hepworth McClave, Brooklyn, NY (US); Sarah Elizabeth Anderson, Ithaca, NY (US); Alejandro Terrazas, Santa Cruz, CA (US); Michael Richard Sheppard, Brooklyn, NY (US); Matt Reid, Alameda, CA (US)

(21) Appl. No.: 14/584,436

(22) Filed: Dec. 29, 2014

(51) Int. Cl. G06Q 30/02; G06Q 50/00

(52) U.S. Cl. CPC G06Q 30/0204; G06Q 50/01

(57) ABSTRACT

Methods, apparatus, systems and articles of manufacture to estimate demographics of an audience of a media event using social media message sentiment are disclosed. An example method includes calculating a sentiment score for a media-exposure social media message received from a social media server. The media-exposure social media message is identified based on a media keyword. Demographic information associated with users who viewed the media-exposure social media message is retrieved. An estimated impact on a size of a demographic segment of viewers is calculated using the sentiment score and the demographic information.

### FIELD OF THE DISCLOSURE

This disclosure relates generally to audience measurement, and, more particularly, to methods and apparatus to estimate demographics of an audience of a media event using social media message sentiment.

### BACKGROUND

Audience measurement of media (e.g., any type of content and/or advertisements such as broadcast television and/or radio, stored audio and/or video played back from a memory such as a digital video recorder or a digital video disc, a webpage, audio and/or video presented (e.g., streamed) via the Internet, a video game, etc.) often involves collection of media identifying information (e.g., signature(s), fingerprint(s), code(s), tuned channel identification information, time of exposure information, etc.). Such audience measurement efforts typically also involve the collection of people data (e.g., user identifier(s), demographic data associated with audience member(s), etc.). The media identifying information and the people data can be combined to generate, for example, media exposure data indicative of amount(s) and/or type(s) of people that were exposed to specific piece(s) of media.

### BRIEF DESCRIPTION OF THE DRAWINGS

FIG. 1 is a diagram of an example environment in which a system constructed in accordance with the teachings of this disclosure operates to estimate demographics of an audience of a media event using social media message sentiment.

FIG. 2 is an example data table that may be stored by the example social media server of FIG. 1 to store demographic information in association with a user.

FIG. 3 is an example data table that may be stored by the example social media server of FIG. 1 to store social media messages.

FIG. 4 is a flowchart representative of example machine-readable instructions that may be executed by the example social media server of FIG. 1 to reply to a request for subscribed messages from a user.

FIG. 5 is a flowchart representative of example machine-readable instructions that may be executed by the example central facility of FIG. 1 to estimate demographics of an audience of a media event using social media message sentiment.

FIG. 6 is an example data table that may be stored by the audience measurement entity of FIG. 1 representing media presentation time ranges and media keywords associated with different media.

FIG. 7 is a flowchart representative of example machine-readable instructions that may be executed by the example social media server of FIG. 1 to reply to a request for social media message impression data and demographic information associated with the impression data.

FIG. 8 is an example data table representing example social media message impression data and demographic information associated with the impression data that may be supplied to the audience measurement entity of FIG. 1 by the social media server of FIG. 1.

FIG. 9 is an example data table that may be stored by the example audience measurement entity of FIG. 1 to associate sentiment keywords with a sentiment modifier.

FIG. 10 is a flowchart representative of example machine-readable instructions that may be executed to calculate a sentiment score of a social media message based on the presence of sentiment keywords in the social media message.

FIG. 11 is an example data table that may be stored by the audience measurement entity of FIG. 1 representing example calculations of a sentiment score.

FIG. 12 is a flowchart representative of example machine readable instructions that may be executed to estimate a size of a demographic segment viewing media based on a sentiment(s) conveyed in social media message(s) presented to users of the demographic segment.

FIG. 13 is an example calculation diagram illustrating example calculations performed according to the example machine-readable instructions of FIG. 11.

FIG. 14 is a block diagram of an example social media server structured to execute the example machine-readable instructions of FIGS. 4 and/or 7 to implement the example social media server of FIG. 1.

FIG. 15 is a block diagram of an example central facility structured to execute the example machine-readable instructions of FIGS. 10 and/or 12 to implement the example audience measurement entity of FIG. 1.

Wherever possible, the same reference numbers will be used throughout the drawing(s) and accompanying written description to refer to the same or like parts.

### DETAILED DESCRIPTION

Monitoring impressions of media (e.g., television (TV) programs, radio programs, advertisements, commentary, audio, video, movies, commercials, websites, etc.) is useful for generating ratings or other statistics for presented media. As used herein, an impression is defined to be an event in which a home or individual is exposed to media (e.g., an advertisement, content, a group of advertisements and/or a collection of content). A quantity of impressions or impression count, with respect to media, is the total number of times homes or individuals have been exposed to the media. For example, in audience metering systems, media identifying information may be detected at one or more monitoring sites when the media is presented (e.g., played at monitored households). In such examples, the collected media identifying information may be sent to a central data collection facility associated with an audience measurement entity (AME) such as The Nielsen Company (US), LLC with people meter data identifying person(s) in the audience for analysis such as the computation of an impression count for the media.

An AME such as The Nielsen Company (US), LLC that monitors and/or reports exposure to media operates as a neutral third party. That is, the audience measurement entity does not provide media (e.g., content and/or advertisements), to end users. This un-involvement with the media production and/or delivery ensures the neutral status of the audience measurement entity and, thus, enhances the trusted nature of the data it collects. The reports generated by the audience measurement entity may identify aspects of media usage such as how many impressions the media received. To ensure that the reports generated by the audience measurement entity are useful to the media providers, it is advantageous to be able to associate media impressions with demographic information. For example, the reports may indicate a number of impressions of media grouped by demographic groups for a time period.

Companies and/or individuals want to understand the reach and effectiveness of the media that they produce and/or sponsor (e.g., thru advertisements). In some examples, media that is associated with a larger number of impressions may be considered more effective at influencing user behavior as it is seen by a larger number of people than media with a fewer number of impressions. Audience measurement entities (sometimes referred to herein as “ratings entities”) traditionally determine media reach and frequency by monitoring registered panel members. That is, an audience measurement entity enrolls people that consent to being monitored into a panel. In such panelist-based systems, demographic information is obtained from a panelist when, for example, the panelist joins and/or registers for the panel. The demographic information (e.g., race, age or age range, gender, income, home location, education level, etc.) may be obtained from the panelist, for example, via a telephone interview, an in-person interview, by having the panelist complete a survey (e.g., an on-line survey), etc. In some examples, demographic information may be collected for a home (e.g., via a survey requesting information about members of the home). However, such panelist systems may be costly to implement at a scale appropriate for accurately identifying and/or estimating the number of exposures of media. Moreover, in view of the increasingly large amount of media distribution channels and media exposure possibilities, collecting a meaningful amount of panelist information (e.g., a statistically significant sample size) for each available media may not be practical.

Examples disclosed herein estimate demographics of audiences using social media message sentiment. For example, examples disclosed herein predict changes in composition (e.g., size and/or demographic distribution) of an audience of media of interest based on (1) a demographic distribution of those exposed to media-exposure social media messages referencing the media of interest and (2) the sentiment of the media-exposure social media messages. Examples disclosed herein identify a social media message indicative of exposure to the media of interest. In examples disclosed herein, social media messages are identified by querying a social media provider. Examples disclosed herein identify a sentiment(s) associated with the respective media-exposure social media message(s) received from the social media provider. In examples disclosed herein, sentiment(s) are identified by calculating a sentiment score based on the presence of positively or negatively valenced keywords in the social media message(s). Examples disclosed herein determine a demographic distribution of users of social messaging services exposed to the respective media-exposure social media message(s) by requesting demographic information from the social media provider. Examples disclosed herein predict a change in the size or demographic composition of an audience that will be exposed to the corresponding media based on a sentiment-demographic profile. As used herein, a media-exposure social media message is a social media message that references at least one media asset (e.g., media and/or a media event). As used herein, a media-exposure social media message of interest is a media-exposure social media message which (1) is posted to a social media site contemporaneously and/or near contemporaneously with a time-window of presentation of the corresponding media, and (2) is accessed (e.g., viewed) at the social media site contemporaneously and/or near contemporaneously with the time-window of presentation of the corresponding media. Media-exposure social media messages will typically include a message that conveys a sentiment about the media. In some examples, different demographic distributions and sentiment combinations may have more impact on changes in the estimated viewership.

From an evolutionary perspective, humans (as well as other animals) are more likely to approach some items in an environment and less likely to approach other items. For example, humans are more likely to approach a puppy and less likely to approach a spider. Users are generally more likely to approach positively valenced items (i.e., puppies, candy, babies) and less likely to approach negatively valenced items (i.e., spiders, garbage, snakes). This concept is also applicable to whether a user will watch a media presentation. In general, users exhibit predictable and quantifiable responses to emotionally valenced textual information. In the context of media measurement, users exhibit predictable and quantifiable responses to emotionally valenced textual information found in social media messages about media (e.g., a television program). For example, positively valenced social media messages about media (e.g., the television program) (e.g., social media messages having a positive sentiment) increase the likelihood that a reader of the social media message will tune-in and/or will continue to watch the media that is the subject of the social media message. In a similar fashion, negatively valenced social media messages (e.g., tweets) about programs should increase the likelihood that readers of those social media messages (e.g., tweets) will not tune-in or avoid the media presentation. For example, users that viewed the social media message “this episode of scandal is great” have a higher likelihood of watching the television show SCANDAL, than users who did not view the social media message.

Using a sentiment analysis approach, features that cause a person to want to view a media presentation (e.g., a television show) after exposure to a media-exposure social media message can be identified. Some media-exposure social media message(s) may indicate an increase in ratings, such as a very positive and enticing event during a show. For example, words in a social media message expressing suspense and/or humor may have different predictive power, and may even differ for the type of television show, as well as at what point the media-exposure social media message occurs. In addition, a positive, yet un-engaging, media-exposure social media message may have no effect, while a suspenseful media-exposure social media message that elicits a positive response in people may draw more viewers to the media.

Social messaging has become a widely used medium in which users disseminate and receive information. Online social messaging services (such as Twitter, Facebook, Instagram, etc.) enable users to send social media messages or instant messages to many users at once. Some social messaging services enable users to “follow” or “friend” other users (e.g., subscribe to receive messages sent by select users (e.g., via the Twitter® service), status updates (e.g., via the Facebook® service or Google+™ social service), etc.). For example, a user following (e.g., subscribed to, online friends with, etc.) a celebrity in the Twitter® service may receive indications via a client application (e.g., the TweetDeck® client application or any other social media messaging client application) when the celebrity sends or posts a social media message.

Social media messages (sometimes referred to herein as “messages,” “statuses,” “texts” or “tweets”) may be used to convey many different types of information. In some examples, social media messages are used to relay general information about a user. For example, a message sender may send a social media message indicating that they are bored. In some examples, social media messages are used to convey information regarding media, a media event, a product, and/or a service. For example, a message sender may convey (e.g., self-report) a social media message indicating that the message sender is watching a certain television program, listening to a certain song, or just purchased a certain book. Social media messages may include different types of text such as, for example, words, abbreviations, acronyms, hashtags, alphanumeric strings, etc. Media-exposure social media messages indicate exposure of at least one media asset to the sender of the message. In some examples disclosed herein, social media messages are collected and then filtered to identify media-exposure social media messages.

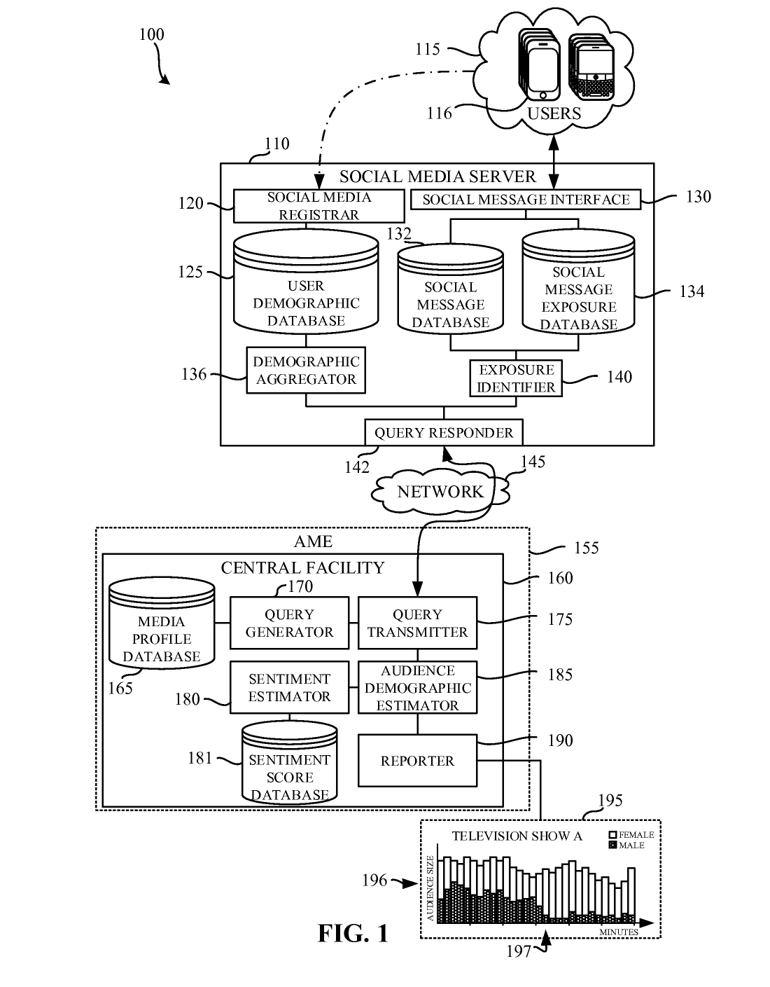

FIG. 1 is a diagram of an example environment in which a system 100 constructed in accordance with the teachings of this disclosure operates to estimate demographics of an audience of a media event using social media message sentiment. The example system 100 of FIG. 1 includes a social media server 110 and a central facility 160 operated by an audience measurement entity (AME) 155. The social media server 110 provides social media services to users 115 of the social media server. As used herein, the term social media services is defined to be a service provided to users to enable users to share information (e.g., text, images, data, etc.) in a virtual community and/or network. Example social media services may include, for example, Internet forums (e.g., a message board), blogs, micro blogs (e.g., Twitter), social networks (e.g., Facebook, LinkedIn, etc.), etc. The example social media server 110 of FIG. 1 includes a social media registrar 120, a user demographic database 125, a social message interface 130, a social message database 132, a social message exposure database 134, a demographic aggregator 136, an exposure identifier 140, and a query responder 142. The example social media server 110 receives queries from the central facility 160 via a network 145. The central facility 160 transmits the queries to gather media-exposure social media messages of interest. The example central facility 160 includes a media profile database 165, a query generator 170, a query transmitter 175, a sentiment estimator 180, an example sentiment score database 181, an audience demographic estimator 185, and a reporter 190.

The example users 115 of the illustrated example of FIG. 1 are users of a social media service provided by the social media server 110. In the illustrated example, the example users 115 access the social media service using a media device 116 such as a mobile device (e.g., a cellular phone, a smartphone, a tablet, etc.). However, the social media service may be accessed in any other fashion such as, for example, using a laptop, a smart television, an in-vehicle infotainment system, etc. In the illustrated example, the user(s) 115 signs into an online social media service with a user identifier to read and/or convey (or send) social media messages. Users may then follow other users (e.g., subscribe to messages of the other users) using the user identifier(s).

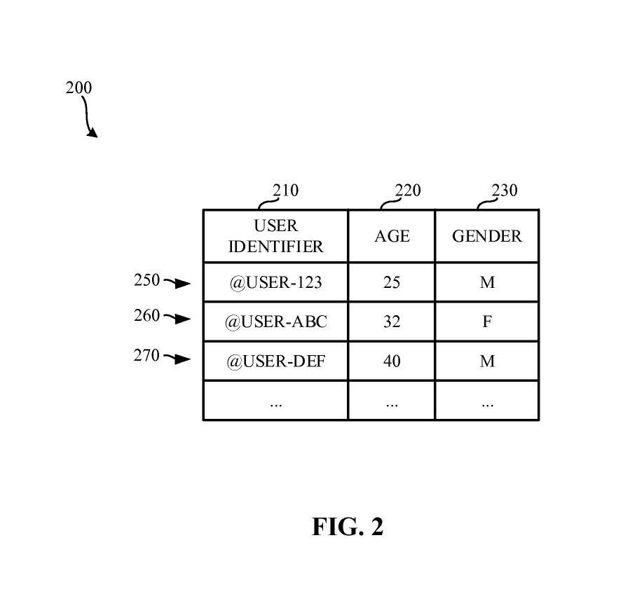

The example registrar 120 of the illustrated example of FIG. 1 receives demographic information from users when users sign up for the social media service. As used herein, demographic information includes, for example, a user's age, gender, geographic location, income, ethnicity, etc. The example registrar 120 receives the demographic information from the user by presenting the user with a webpage including a form and receiving a response from the user. However, any other approach to gathering the demographic information may additionally or alternatively be used such as, for example, via a telephone interview, an in-person interview, by having the user complete a survey (e.g., an on-line survey), etc. When the example registrar 120 has collected the demographic information, the demographic information is stored in the example user demographic database 125 in association with a user identifier of the user. An example data table 200 representing demographic information stored in association with the user identifier is shown in the illustrated example of FIG. 2.

The example user demographic database 125 of the illustrated example of FIG. 1 stores demographic information received via the registrar 120 in association with user identifiers. Such association enables identification of demographic information associated with users who received a social media message. The example user demographic database 125 may be implemented by a volatile memory (e.g., a Synchronous Dynamic Random Access Memory (SDRAM), Dynamic Random Access Memory (DRAM), RAMBUS Dynamic Random Access Memory (RDRAM, etc.) and/or a non-volatile memory (e.g., flash memory). The example user demographic database 125 may additionally or alternatively be implemented by one or more double data rate (DDR) memories, such as DDR, DDR2, DDR3, mobile DDR (mDDR), etc. The example user demographic database 125 may additionally or alternatively be implemented by one or more mass storage devices such as hard drive disk(s), compact disk drive(s), digital versatile disk drive(s), etc. While in the illustrated example the user demographic database 125 is illustrated as a single database, the user demographic database 125 may be implemented by any number and/or type(s) of databases.

The example social message interface 130 of the illustrated example of FIG. 1 enables users to receive messages posted by to the social message service. For example, when the user 115 operates their media device 116, the social message interface 130 receives a request for social media messages to be presented to the user. The social message interface 130 gathers messages to be transmitted to the requesting user. In the illustrated example, the social message interface 130 gathers messages that were posted by users to whom the requesting user has subscribed. However, in some examples, the requesting user may have requested messages that were posted by a user other than a user to whom the requesting user has subscribed. In examples disclosed herein, the example social message interface 130 records when an impression of a social media message occurs in the social media exposure database 134. In the illustrated example, impressions are recorded when the social media message is transmitted to the user. However, in some examples, the impressions are recorded when a receipt message is received from the media device indicating that the social media message was presented to the user.

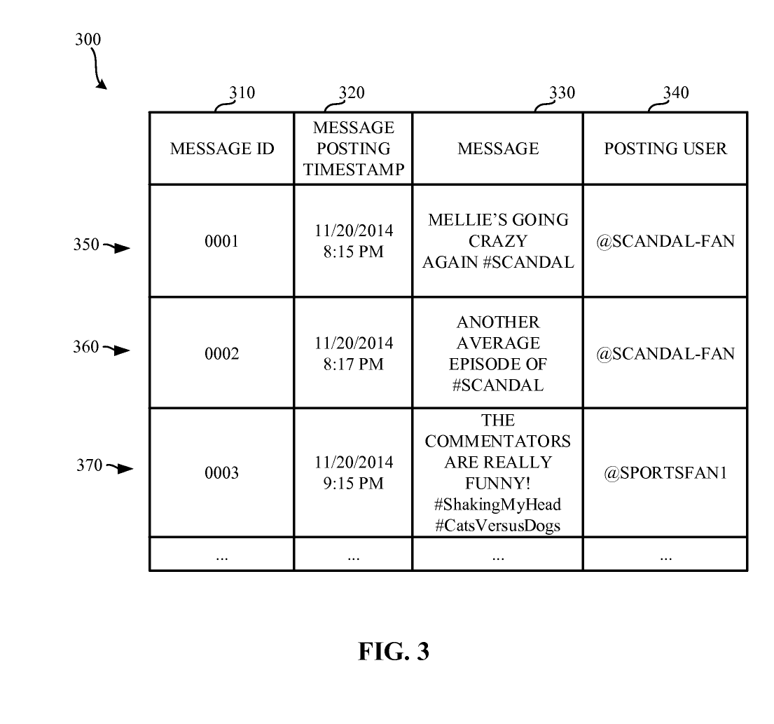

The example social message database 132 of the illustrated example of FIG. 1 records social media messages posted by users of the social media service and a timestamp(s) associated with the posting of the message(s). In some examples, a username of the user posting the social media message is stored. Storing the username of the posting user enables identification that the social media message should be presented to a user who is subscribed to the posting user. An example data table 300 of the illustrated example of FIG. 3 illustrates example data that may be stored in the example social message database 132. The example social message database 132 may be implemented by a volatile memory (e.g., a Synchronous Dynamic Random Access Memory (SDRAM), Dynamic Random Access Memory (DRAM), RAMBUS Dynamic Random Access Memory (RDRAM, etc.) and/or a non-volatile memory (e.g., flash memory). The example social message database 132 may additionally or alternatively be implemented by one or more double data rate (DDR) memories, such as DDR, DDR2, DDR3, mobile DDR (mDDR), etc. The example social message database 132 may additionally or alternatively be implemented by one or more mass storage devices such as hard drive disk(s), compact disk drive(s), digital versatile disk drive(s), etc. While in the illustrated example the social message database 132 is illustrated as a single database, the social message database 132 may be implemented by any number and/or type(s) of databases.

The example social message exposure database 134 of the illustrated example of FIG. 1 stores social media message exposure information. In examples disclosed herein, the social media message exposure information includes a message identifier, a timestamp indicating the time of exposure, and a user identifier to whom the social media message was presented. The example social media message exposure database 134 is useful because it enables identification of users who were presented with a particular message of interest during a given time range. The example social message exposure database 134 may be implemented by a volatile memory (e.g., a Synchronous Dynamic Random Access Memory (SDRAM), Dynamic Random Access Memory (DRAM), RAMBUS Dynamic Random Access Memory (RDRAM, etc.) and/or a non-volatile memory (e.g., flash memory). The example social message exposure database 134 may additionally or alternatively be implemented by one or more double data rate (DDR) memories, such as DDR, DDR2, DDR3, mobile DDR (mDDR), etc. The example social message exposure database 134 may additionally or alternatively be implemented by one or more mass storage devices such as hard drive disk(s), compact disk drive(s), digital versatile disk drive(s), etc. While in the illustrated example the social message exposure database 134 is illustrated as a single database, the social message exposure database 134 may be implemented by any number and/or type(s) of databases.

The example demographic aggregator 136 of the illustrated example of FIG. 1 aggregates demographic information for selected users in response to a query received by the query responder 142. An important aspect of any monitoring system is maintaining the privacy of those users who are monitored in accordance with their wishes. To that end, the social media server 110 does not provide user names identifying users who were presented with a social media message. Instead, the example demographic aggregator 136 summarizes demographic information of a list of identified users when a number of users identified in response to a query meets or exceeds a user threshold (e.g., one hundred users). Using a user threshold ensures that any one user in the list of users is not individually identifiable. The example demographic aggregator 136 aggregates the demographic information into segments and/or market breaks such as, for example, 70% male age 20-29, 20% female age 20-29, 6% male age 30-39, 4% female age 30-39. However, any other approach to aggregating demographic information may additionally or alternatively be used.

In some examples, in addition to and/or as an alternative to providing aggregated demographic information, the social media server 110 provides a list of usernames to the central facility 160. In some examples, the AME requests a username from users when they agree to become panelists (i.e., as part of a monitoring study). By providing the username to the AME, the AME can validate demographic information provided by the demographic aggregator 136 against the demographic information provided by the user and/or may aggregate demographic information on its own.

The example exposure identifier 140 of the illustrated example of FIG. 1 gathers social media message exposure information identifying the list of users that were presented with a media-exposure social media message that meets the criteria of a request received from the AME 155 via the query responder 142. The example exposure identifier 140 inspects the example social message database 132 and/or the example social message database 134 to identify social media message(s) and a list of users associated those identified social media messages that include keywords of interest and where the exposure occurred during a first time period (e.g., within a particular five minute interval of a live television presentation).

In some examples, the example exposure identifier 140 further limits results to social media messages that were presented during a second time period (e.g., social media messages that were posted ten minutes or less before the airing of the live television presentation, social media messages that were posted during the airing of the live television presentation, etc.). In some examples, the first time period and the second time period are the same (e.g., resulting in identification of social media messages that were both posted and viewed in the same time period). In the illustrated example, the example exposure identifier 140 operates SQL queries against the example social message database 132 and/or the example social message database 134 to identify social media message(s) and a list of users associated those identified social media messages. However, any other approach to accessing the data may additionally or alternatively be used.

The example query responder 142 of the illustrated example of FIG. 1 receives one or more queries from the AME 155 via the network 145. In the illustrated example, the one or more queries indicate media keywords and a time period. The media keywords are keywords that are associated with particular media (e.g., a television show) and result in social media messages that are relevant to the particular media being identified. In examples disclosed herein, the media keywords are selected by the AME to closely correspond to media of interest. For example, the media keywords may include a title of the media, an episode name, a name of a character in the media, a name of an actor, a phrase used in the media, etc.

In the illustrated example, the one or more query(ies) received from the AME 155 indicate a time period of social media message exposure of interest. In the illustrated example, the time period is represented by a start time and a stop time. However, the time period may be represented in any other fashion such as, for example, a start time and a duration. Moreover, in some examples, the query may request that the results be divided into smaller intervals (e.g., return results for a 30 minute television show broken down by five minute increments).

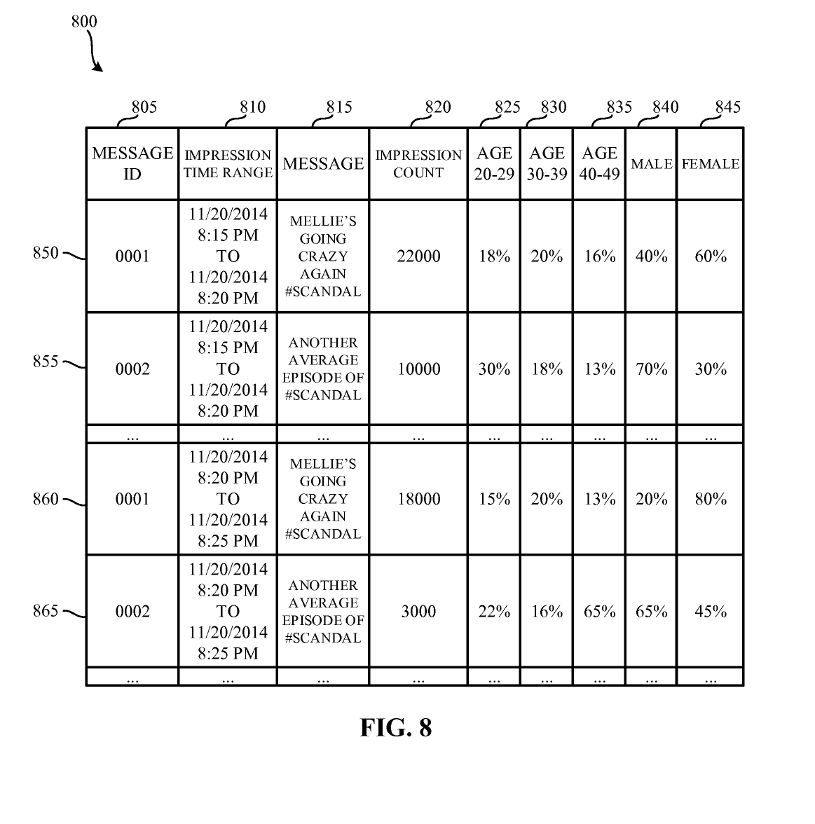

The example query responder 142 interacts with the example exposure identifier 140 and the example demographic aggregator 136 to gather results to transmit to the AME 155 in response to the query received from the AME 155. As such, the example query responder 142 provides a unified interface from which the central facility 160 can request demographic information and social media exposure information. An example data table 800 representing example results returned to the AME 155 by the example query responder is shown in the illustrated example of FIG. 8.

The example network 145 of the illustrated example of FIG. 1 is the Internet. However, the example network 145 may be implemented using any suitable wired and/or wireless network(s) including, for example, one or more data buses, one or more Local Area Networks (LANs), one or more wireless LANs, one or more cellular networks, etc. The example network 145 enables the central facility 160 to be in communication with the social media server 110. As used herein, the phrase “in communication,” including variances thereof, encompasses direct communication and/or indirect communication through one or more intermediary components and does not require direct physical (e.g., wired) communication and/or constant communication, but rather includes selective communication at periodic or aperiodic intervals, as well as one-time events.

The example AME 155 of the illustrated example of FIG. 1 is an entity such as The Nielsen Company (US), LLC that monitors and/or reports exposure to media operates as a neutral third party. The example AME 155 operates the central facility 160 to monitor and/or report such media exposure. The example central facility 160 of the illustrated example of FIG. 1 is a server operated by the AME 155. Although only one central facility 160 is shown in FIG. 1, many facilities may be provided for collecting the data. In some examples, these data collection facilities are structured in a tiered approach with many satellite collection facilities collecting data and forwarding the same to one or more central facilities 160.

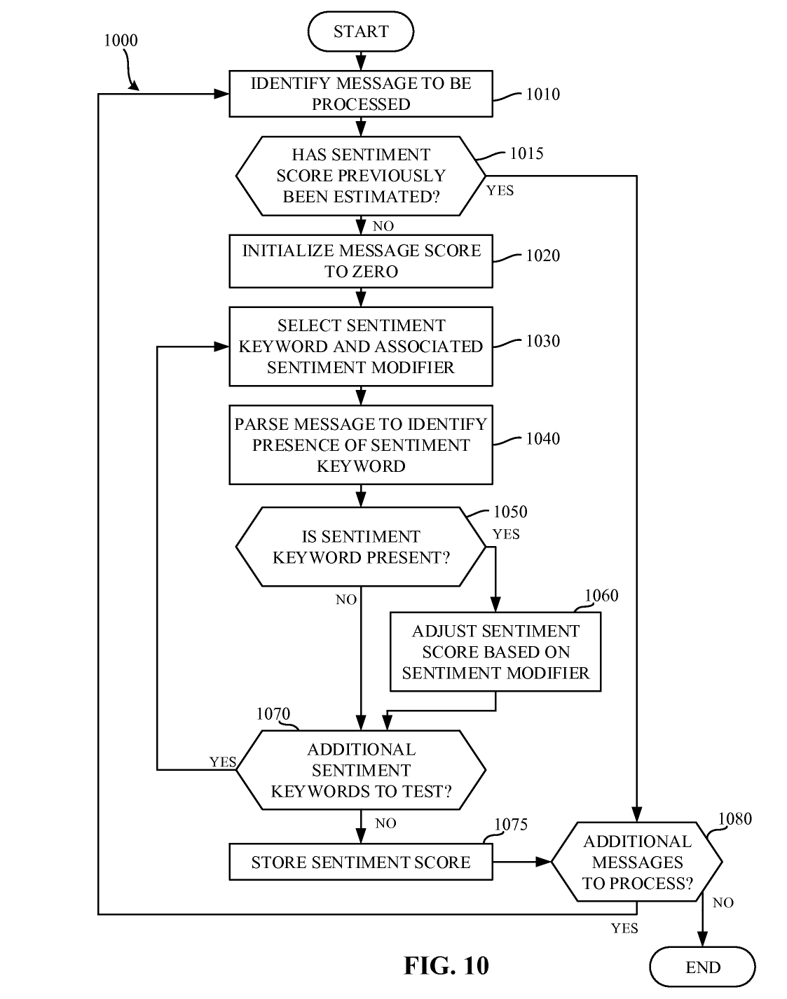

The example media profile database 165 of the illustrated example of FIG. 1 stores media profile information such as a media identifier, a media time range, media keywords, etc. The media profile information stored by the media profile database 165 enables the example query generator 170 to generate a query to transmit to the social media server 110. An example data table 1000 representing the example media profile information is represented in the illustrated example of FIG. 10. The example media profile database 165 may be implemented by a volatile memory (e.g., a Synchronous Dynamic Random Access Memory (SDRAM), Dynamic Random Access Memory (DRAM), RAMBUS Dynamic Random Access Memory (RDRAM, etc.) and/or a non-volatile memory (e.g., flash memory). The example media profile database 165 may additionally or alternatively be implemented by one or more double data rate (DDR) memories, such as DDR, DDR2, DDR3, mobile DDR (mDDR), etc. The example media profile database 165 may additionally or alternatively be implemented by one or more mass storage devices such as hard drive disk(s), compact disk drive(s), digital versatile disk drive(s), etc. While in the illustrated example the media profile database 165 is illustrated as a single database, the media profile database 165 may be implemented by any number and/or type(s) of databases.

The example query generator 170 of the illustrated example of FIG. 1 reads media profiles from the media profile database 165 and generates queries to be transmitted to the social media server 110. In the illustrated example, the query(ies) request all social media messages and demographic data associated with impressions of those social media messages where the social media message contains media keywords (from the media profile) and the impressions occurred during a particular time window (as indicated by the media profile). Based on the current time and times at which various media is presented, the example query generator 170 determines which queries should be generated. For example, queries related to a television show that airs on Thursday evening need not be transmitted to identify exposure to social media messages on a Monday morning, as exposure to social media messages on Monday morning is not likely to have an effect on the audience on Thursday evening. In examples disclosed herein, the example query generator 170 generates queries to be transmitted up to two hours prior to the beginning of a media presentation and up until the end of the media presentation. However, any other time period may additionally or alternatively be used for preparing queries. Additionally or alternatively, instead of generating queries as they are to be transmitted, the example query generator 170 may generate queries ahead of time and cache the pre-generated queries.

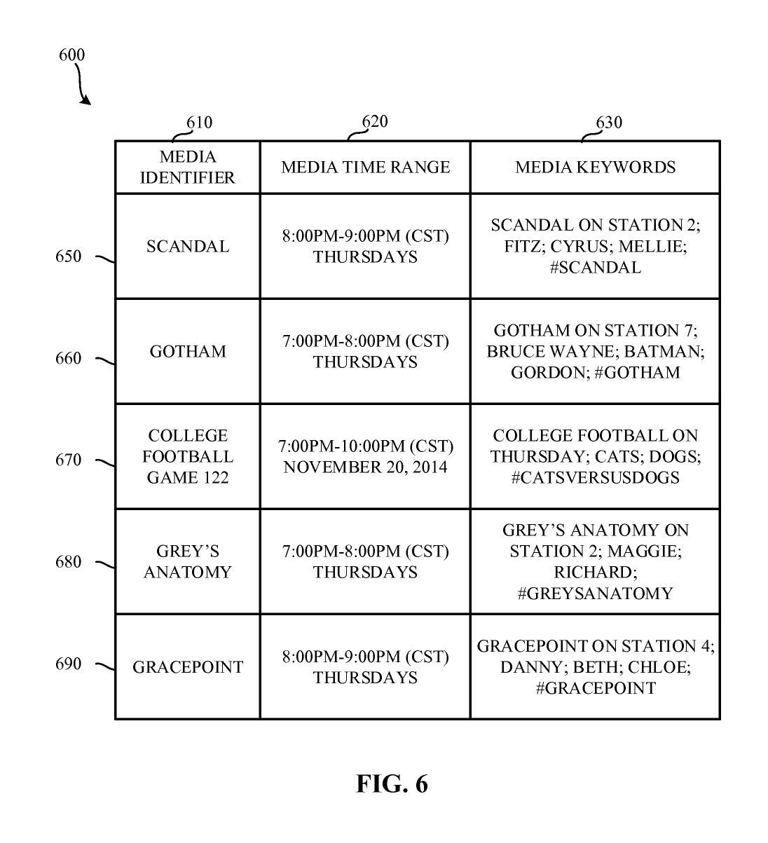

The example query transmitter 175 of the illustrated example of FIG. 1 transmits the queries generated by the query generator 170 to the query responder 142. In the illustrated example, the queries are transmitted via the network 145 as the results of those queries are needed for analysis (e.g., at the end of a time period). For example, a query may request media-exposure social message information and demographic information associated therewith relevant to a particular media for the past five minutes. However, in some examples, the queries may be transmitted to the query responder 142 ahead of time, and results may be returned upon expiration of the time period. In the illustrated example, the queries and their associated results are transmitted via the network 145. However, the queries and their associated results may be transmitted in any other fashion. In response to the query, the example query transmitter 175 receives the social media message and impression information (e.g., a number of impressions of the social media message during the requested time range and demographic breakdowns of those impressions). An example data table 600 representing responses to queries is shown in the illustrated example of FIG. 6.

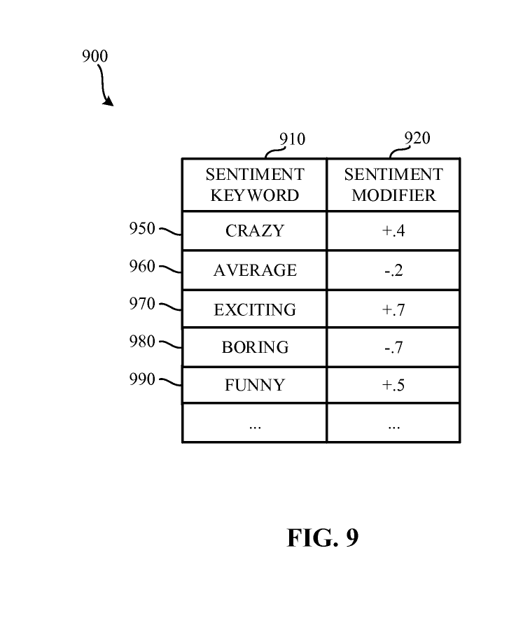

The example sentiment estimator 180 of the illustrated example of FIG. 1 calculates a sentiment score for identified media-exposure social media messages as they pertain to media to which the social media users/posters are exposed. The example sentiment estimator 180 calculates the sentiment score by identifying sentiment keywords that are associated with various sentiments within the media-exposure social media messages. When present in media-exposure social media messages, sentiment keywords can cause a change in the probability that a user will be attracted to the identified media. The sentiment score is a numeric factor that is used as an indicator of likelihood of whether a user who is exposed to a sentiment keyword will be attracted towards or away from the identified media. The example sentiment estimator 180 consults a list of sentiment keywords and associated sentiment modifiers to determine if any of the sentiment keywords are present in the media-exposure social media message. As used herein, a sentiment modifier is a numeric value indicating a positive and/or negative sentiment, and a strength of the sentiment. As disclosed herein, sentiment modifiers are derived from an empirical study of user reactions to various keywords. However, sentiment modifiers may be derived in any other fashion. An example list of sentiment keywords and associated sentiment modifiers is shown in the example data table 900 of FIG. 9.

The example sentiment estimator 180 of FIG. 1 parses the media-exposure social media message to identify sentiment keywords. When a sentiment keyword is identified in the media-exposure social media message, the sentiment modifier associated with that sentiment keyword is used to modify the sentiment score for the media-exposure social media message. In examples disclosed herein, the sentiment modifier is added to the running sentiment score for the media-exposure social media message. When, for example, the sentiment modifier is negative, the sentiment modifier may be subtracted from the running sentiment score for the media-exposure social media message (e.g., the user is likely to tune out, or not watch the media presentation). While addition and/or subtraction is used in the illustrated example, any other approach to calculating the sentiment score may additionally or alternatively be used. For example, sentiment modifiers associated with sentiment keywords present in the media-exposure social media message may be averaged to identify the sentiment score.

Moreover, additional techniques, such as natural language processing may be used to identify whether a social media message is likely to be engaging to users. Moreover, in some examples, a score associated with the posting user of the social media message may be used in calculating the sentiment score. For example, a highly influential user (e.g., a user having many followers and/or subscribers) making a positively valenced social media message (e.g., a social media message having a positive sentiment score) may attract more users than the same message would have attracted if it were posted by a user who is not influential (e.g., a user having fewer subscribers). In some examples, the sentiment score is normalized and/or further processed. For example, upper and/or lower limits may be placed on the sentiment score to, for example, ensure that subsequent calculations performed using the sentiment score do not result in more users being attracted to the media than were presented with the media-exposure social media message.

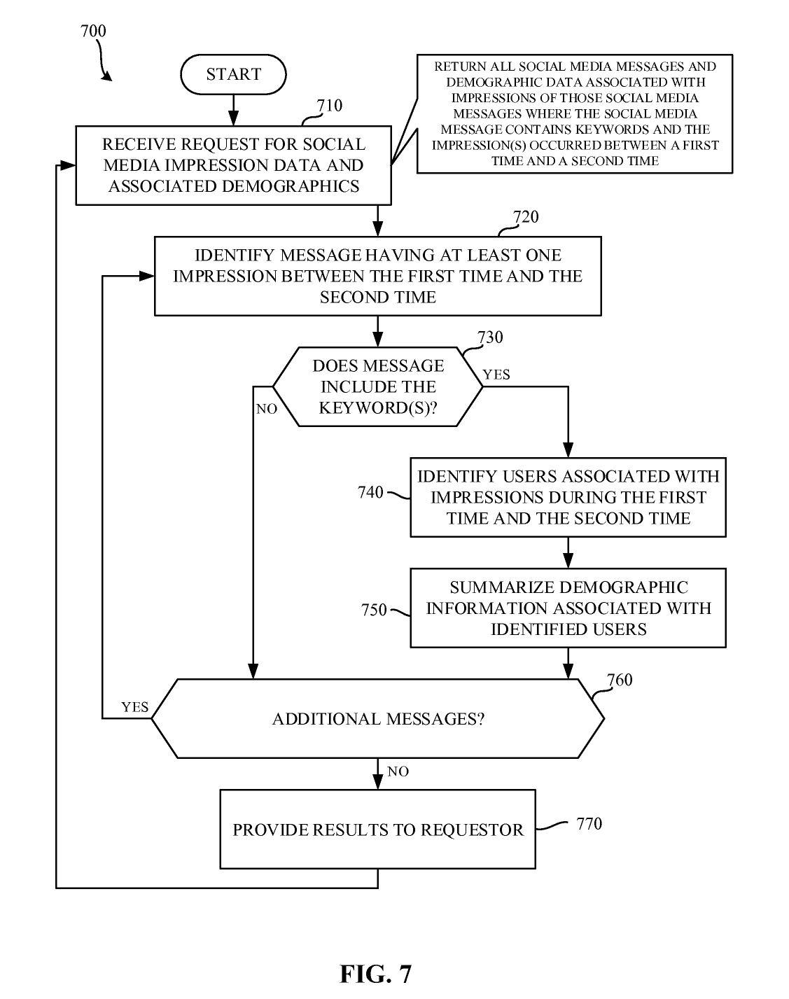

The example sentiment estimator 180 stores computed a sentiment score(s) and/or information used for generating such sentiment score(s) in the sentiment score database 181. Example data tables 700, 900 representing example data that may be stored in the example sentiment score database 181 are shown in the illustrated examples of FIGS. 7 and/or 9. The example sentiment score database 181 may be implemented by a volatile memory (e.g., a Synchronous Dynamic Random Access Memory (SDRAM), Dynamic Random Access Memory (DRAM), RAMBUS Dynamic Random Access Memory (RDRAM, etc.) and/or a non-volatile memory (e.g., flash memory). The example sentiment score database 181 may additionally or alternatively be implemented by one or more double data rate (DDR) memories, such as DDR, DDR2, DDR3, mobile DDR (mDDR), etc. The example sentiment score database 181 may additionally or alternatively be implemented by one or more mass storage devices such as hard drive disk(s), compact disk drive(s), digital versatile disk drive(s), etc. While in the illustrated example the sentiment score database 181 is illustrated as a single database, the sentiment score database 181 may be implemented by any number and/or type(s) of databases.

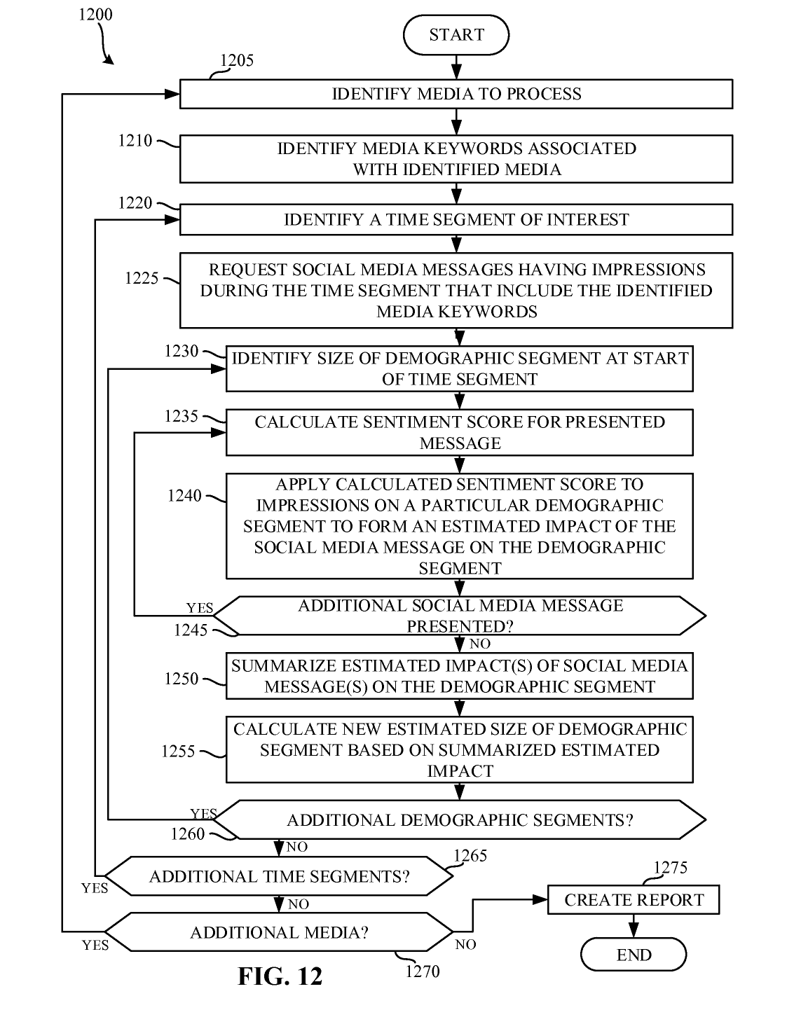

The example audience demographic estimator 185 of the illustrated example of FIG. 1 applies the sentiment score(s) calculated by the example sentiment estimator 180 to the demographic information provided by the social media server 110 to identify an estimated impact of the presentation of the media-exposure social media message on the demographic population(s) to which it was presented. In the illustrated example, a count of the number of users within a demographic segment is multiplied by the sentiment score to identify the estimated impact of the social media message. Because multiple media-exposure social media messages, which likely have different calculated sentiment scores, may be presented during a time period (e.g., one minute, five minutes, etc.) the audience demographic estimator 185 aggregates the estimate impact(s) of those media-exposure social media message(s) by adding them together. However, any other approach to aggregating the estimated impact(s) may additionally or alternatively be used such as, for example, averaging, identifying a median, etc. The summarized estimated impact of the media-exposure social media messages is combined with a previous audience state of the audience (e.g., a number of persons within a demographic segment who are presented with the media of interest), representing users to whom the media is presented at a beginning of a time period, to form an estimated audience state at an end of the time period. An example calculation diagram 1200 showing example calculations performed by the example audience demographic estimator 185 is described below in connection with the illustrated example of FIG. 12.

The example reporter 190 of the illustrated example of FIG. 1 generates one or more reports identifying a demographic composition of an audience using the audience state values calculated by the example audience demographic estimator 185. In the illustrated example of FIG. 1, the example reporter 190 creates a report 195 indicating a demographic breakdown of male versus female viewers of a television show. In the illustrated example, the example report 195 is a bar graph identifying a composition of audience over time. However, any other approach to representing the demographic breakdown of an audience may additionally or alternatively be used. A vertical axis 196 of the report indicates the composition of the audience. In particular, the vertical axis 196 of the example report 195 of FIG. 1 identifies a breakdown of the audience by gender. Portions of the example report 195 that are shaded represent male viewers, while portions of the example report 195 that are not shaded represent female viewers. While in the illustrated example, the example report 195 identifies the breakdown of the audience by gender, any other demographic characteristics may additionally or alternatively be used such as, for example, race, income, age, etc. A horizontal axis 197 of the report 195 indicates time from the beginning of the television show. Each vertical bar of the example report 195 is illustrative of a one minute segment of the television show. However, any other length of segment(s) may additionally or alternatively be used. The example report 195 indicates that the audience composition is relatively equal for males and females for the first fifteen minutes of the television show. However, after the fifteen minute mark, the audience for the television show is predominantly female.

FIG. 2 is an example data table 200 that may be stored by the example social media server of FIG. 1 to store demographic information in association with a user. The example data table 200 includes a user identifier column 210, an age column 220, and a gender column 230. However, any other columns representing any other demographic information may additionally be used. Moreover, the example column(s) may be implemented in any other fashion. For example, the example age column 220 of the illustrated example identifies an age of the user. In some examples, the age column may store a birthdate of the user, such that an age of the user may be later calculated. The example user identifier column 210 of the illustrated example of FIG. 2 stores the username of the user of the social media service provided by the social media server 110. However, in some examples, the example user identifier column 210 may store an altered and/or obfuscated version of the username (e.g., a hashed version of the username). Using an altered and/or obfuscated version of the username ensures that if a list of usernames were to be provided to the central facility 160, that the users would not be personally identifiable.

The example data table 200 of the illustrated example includes three example rows 250, 260, 270. The first row 250 indicates that “@USER-123” is a twenty five year old male. The second row 260 indicates that “@USER-ABC” is a thirty two year old female. The third row indicates that “@USER-DEF” is a forty year old male. While in the illustrated example of FIG. 2, three example rows are shown corresponding to three example users, in practice it is expected that many users will be represented in the example data table corresponding to the many users of the social media service provided by the social media server 110.

FIG. 3 is an example data table 300 that may be stored by the example social media server 110 of FIG. 1 to store social media messages. The example data table 300 of the illustrated example of FIG. 3 includes a message identifier column 310, a message posting timestamp column 320, a message column 330, and a posting user column 340. The example message identifier column 310 indicates an identifier of a message posted using the social media service provided by the social media server 110. In the illustrated example, the message identifier is a unique serial identifier. However, any other approach to uniquely identifying a message may additionally or alternatively be used.

The example message posting timestamp column 320 indicates a date and/or time at which the message identified by the message identifier column 310 was posted to the social media service. The example message column 330 indicates the message that was posted to the social media service. The example posting user column 340 identifies a username of the user that posted the social media message to the social media service provided by the social media server 110. The example posting user column 340 is used by the social media server 110 when providing social media messages to users.

The example data table 300 of the illustrated example of FIG. 3 includes three example rows 350, 360, 370, corresponding to three example social media messages. The first row 350 indicates that a message having an identifier of “0001” and a text of “MELLIE'S GOING CRAZY AGAIN #SCANDAL” was posted by “@SCANDAL-FAN” at 8:15 PM on Nov. 20, 2014. The second row 360 indicates that a message having an identifier of “0002” and a text of “ANOTHER AVERAGE EPISODE OF #SCANDAL” was posted by “@SCANDAL-FAN” at 8:17 PM on Nov. 20, 2014. The third row 370 indicates that a message having an identifier of “0002” and a text of “THE COMMENTATORS ARE REALLY FUNNY! @ShakingMyHead #CatsVersusDogs” was posted by “@SPORTSFAN1” at 9:15 PM on Nov. 20, 2014. While three example messages are represented in the example data table 300 of FIG. 3, in practice it is expected that many additional social media messages will be used.

While an example manner of implementing the example social media server 110 of FIG. 1 is illustrated in FIG. 1, and an example manner of implementing the example central facility 160 of FIG. 1 is illustrated in FIG. 1, one or more of the elements, processes and/or devices illustrated in FIG. 1 may be combined, divided, re-arranged, omitted, eliminated and/or implemented in any other way. Further, the example social media registrar 120, the example user demographic database 125, the example social message interface 130, the example social message database 132, the example social message exposure database 134, the example demographic aggregator 136, the example exposure identifier 140, the example query responder 142, and/or more generally the example social media server 110 of FIG. 1, and/or the example media profile database 165, the example query generator 170, the example query transmitter 175, the example sentiment estimator 180, the example sentiment score database 181, the example audience demographic estimator 185, the example reporter 190, and/or, more generally, the example central facility of FIG. 1 may be implemented by hardware, software, firmware and/or any combination of hardware, software and/or firmware. Thus, for example, any of the example social media registrar 120, the example user demographic database 125, the example social message interface 130, the example social message database 132, the example social message exposure database 134, the example demographic aggregator 136, the example exposure identifier 140, the example query responder 142, and/or more generally the example social media server 110 of FIG. 1, and/or the example media profile database 165, the example query generator 170, the example query transmitter 175, the example sentiment estimator 180, the example sentiment score database 181, the example audience demographic estimator 185, the example reporter 190, and/or, more generally, the example central facility of FIG. 1 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example social media registrar 120, the example user demographic database 125, the example social message interface 130, the example social message database 132, the example social message exposure database 134, the example demographic aggregator 136, the example exposure identifier 140, the example query responder 142, and/or more generally the example social media server 110 of FIG. 1, and/or the example media profile database 165, the example query generator 170, the example query transmitter 175, the example sentiment estimator 180, the example sentiment score database 181, the example audience demographic estimator 185, the example reporter 190, and/or, more generally, the example central facility of FIG. 1 is/are hereby expressly defined to include a tangible computer readable storage device or storage disk such as a memory, a digital versatile disk (DVD), a compact disk (CD), a Blu-ray disk, etc. storing the software and/or firmware. Further still, the example social media server 110 of FIG. 1 and/or the example central facility 160 of FIG. 1 may include one or more elements, processes and/or devices in addition to, or instead of, those illustrated in FIG. 1, and/or may include more than one of any or all of the illustrated elements, processes and devices.

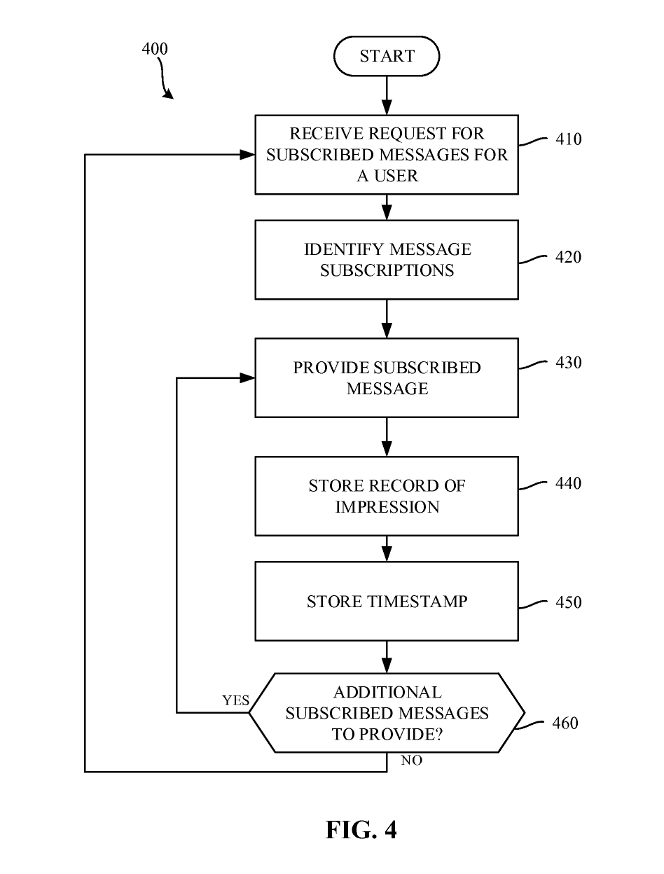

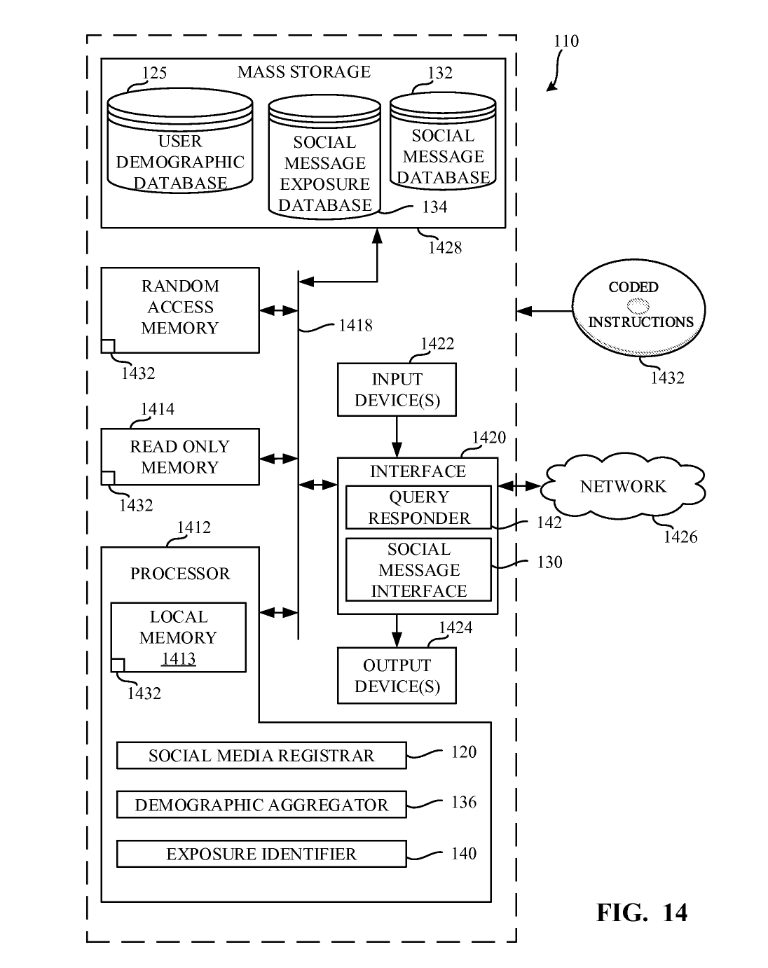

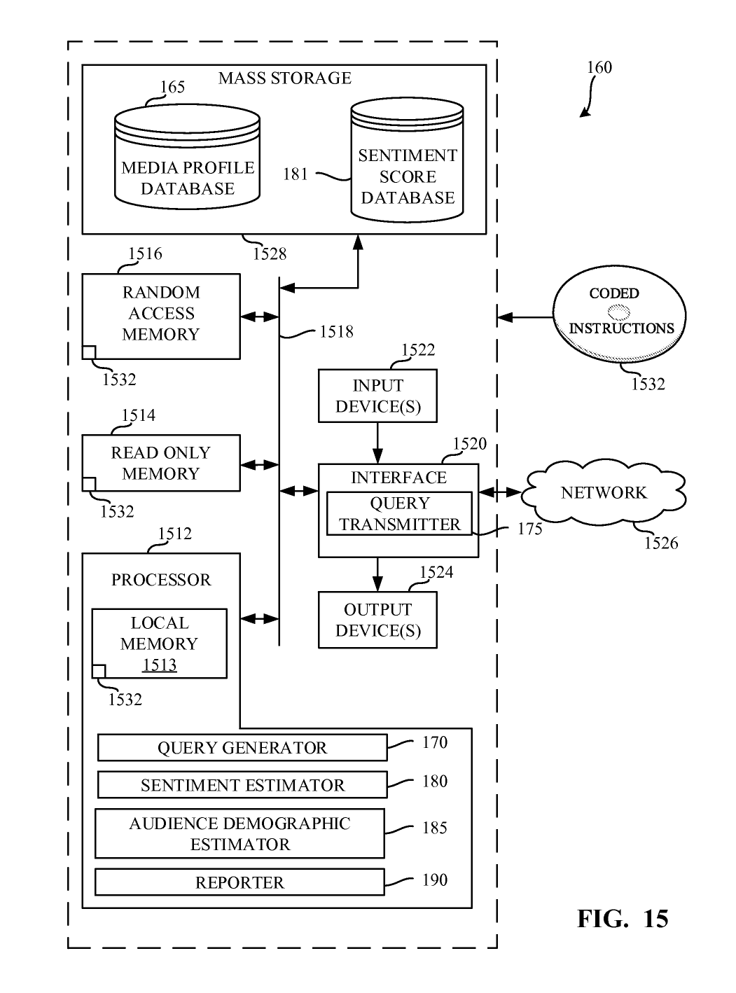

Flowcharts representative of example machine-readable instructions for implementing the example social media server 110 of FIG. 1 are shown in FIGS. 4 and/or 7. Flowcharts representative of example machine readable instructions for implementing the example central facility 160 are shown in FIGS. 10 and/or 12. In these example(s), the machine readable instructions comprise a program(s) for execution by a processor such as the processor 1412 shown in the example server 1400 discussed below in connection with FIG. 14 and/or the processor 1512 shown in the example central facility 1500 discussed below in connection with FIG. 15. The program(s) may be embodied in software stored on a tangible computer readable storage medium such as a CD-ROM, a floppy disk, a hard drive, a digital versatile disk (DVD), a Blu-ray disk, or a memory associated with the processor 1412, 1512, but the entire program and/or parts thereof could alternatively be executed by a device other than the processor 1412, 1512 and/or embodied in firmware or dedicated hardware. Further, although the example program(s) is/are described with reference to the flowchart illustrated in FIGS. 4, 7, 10, and/or 12, many other methods of implementing the example social media server 110 and/or the example central facility 160 may alternatively be used. For example, the order of execution of the blocks may be changed, and/or some of the blocks described may be changed, eliminated, or combined.

As mentioned above, the example processes of FIGS. 4, 7, 10, and/or 12 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and transmission media. As used herein, “tangible computer readable storage medium” and “tangible machine readable storage medium” are used interchangeably. Additionally or alternatively, the example processes of FIGS. 4, 7, 10, and/or 12 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and transmission media. As used herein, when the phrase “at least” is used as the transition term in a preamble of a claim, it is open-ended in the same manner as the term “comprising” is open ended.

FIG. 4 is a flowchart representative of example machine-readable instructions 400 that may be executed by the example social media server 110 of FIG. 1 to reply to a request for subscribed messages from a user. The example instructions 400 of the illustrated example of FIG. 4 begin when the example social message interface 130 receives a request for subscribed messages for a particular user. (Block 410). In the illustrated example, the request is received via the network 145 from the media device 116 of the user 115. However, the request may be received in any fashion and/or from any device associated with the user 115. The example request identifies the requesting user by including, for example, a user identifier in the payload of the request. Using the identity of the requesting user, the example social message interface 130 identifies message subscriptions of the requesting user 115. (Block 420). In the illustrated example, the message subscriptions are identified by determining which other users the requesting user is subscribed to, and retrieving messages posted by those users from the social message database 132. The example social message interface 130 provides a subscribed message to the media device 116 device requesting the subscribed message(s). (Block 430). In the illustrated example, the subscribed message is provided via the network 145. However, any other approach to providing the subscribed message to the requesting media device may additionally or alternatively be used. The example social message interface 130 stores a record of the impression of the social media message to the requesting user. (Block 440). In the illustrated example, the example social message interface 130 stores a record in the social message exposure database 134 to indicate that the identified user was presented with the social media message. However, any other approach to recording an impression of a social media message may additionally or alternatively be used. For example, the example social message interface 130 may await a confirmation message from the media device 116 that requested the subscribed message(s) that indicates that the media device presented the subscribed message to the user.

The example social message interface 130 stores a timestamp indicating that the date and/or time of the impression in the social message exposure database 134. (Block 450). Storing a timestamp (e.g., a date and/or a time that an event occurred) enables later determination of when a given message was presented to a user. Moreover, the timestamps enable aggregation among multiple exposures to social media messages to identify, for example, a number of exposures to a particular social media message that occurred in a given timeframe.

The example social message interface 130 then determines whether an additional subscribed message(s) are available to be provided to the media device 116 of the requesting user 115. (Block 460). In the illustrated example, the social message interface 130 compares subscribed messages of the social message database 132 to records of impression in the social message exposure database 134. If, for example, the requesting user is subscribed to a social media message, but that social media message has not yet been provided to the requesting user, control may proceed to block 430, where the example social message interface 130 may provide the subscribed message to the requesting user. If no additional subscribed messages are to be provided to the requesting user (Block 460), the example social message interface 130 awaits a further request for subscribe messages.

While in the illustrated example, the example instructions 400 of FIG. 4 represent a single iteration of providing subscribed messages to a user, in practice, the example instructions 400 of the illustrated example of FIG. 4 may be executed in parallel (e.g., in separate threads) to allow the social media server 110 to handle multiple requests for subscribed messages from multiple users at a time.

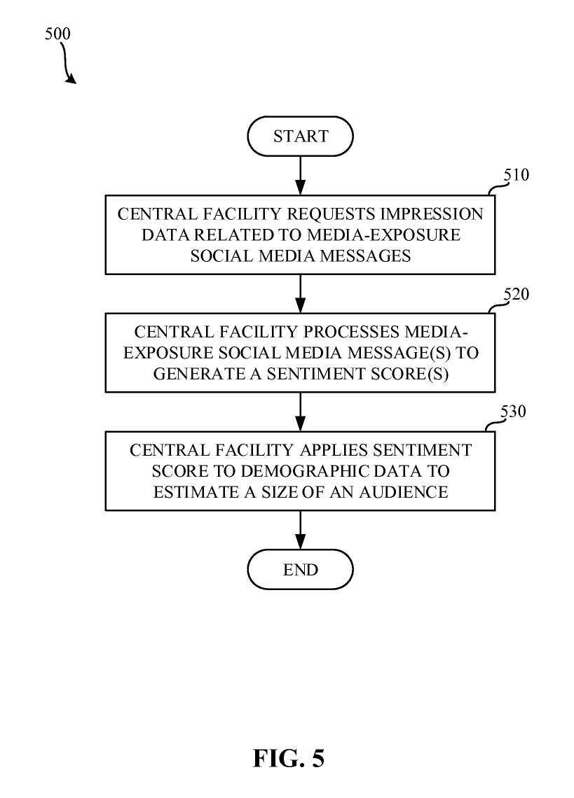

FIG. 5 is a flowchart representative of example machine-readable instructions that may be executed by the example central facility 160 of FIG. 1 to estimate demographics of an audience of a media event using social media message sentiment. The example process 500 of the illustrated example of FIG. 5 begins when the example central facility 160 requests media-exposure social media messages and impression data (e.g., a number of impressions, a demographic breakdown of those impressions, etc.) related thereto from the social media server 110. (Block 510). In the illustrated example, the example central facility 160 consults the example data table 600 of the illustrated example of FIG. 6 to determine when the impression data should be requested from the social media server 110, as well as identifying media keywords that are used to associate media-exposure social media messages with particular media. Example impression data received in response to the request may be formatted in a manner described in connection with the example data table 800 of FIG. 8. Upon receipt of the impression data and demographic data associated therewith, the example central facility 160 processes the media-exposure social media messages to generate sentiment score(s) associated with the returned media-exposure social media messages. (Block 520). An example approach to generating a sentiment score is described below in connection with FIGS. 9, 10, and/or 11. The example central facility applies the sentiment score to the demographic data to estimate a size of the audience of the media identified by the media keywords. (Block 530). An example approach to applying the sentiment score to impression data is described below in connection with FIGS. 12 and/or 13.

FIG. 6 represents an example data table 600 that may be stored by the audience measurement entity 155 of FIG. 1 representing media presentation time ranges and media keywords associated with different media. The example data table 600 of the illustrated example of FIG. 6 is stored in the example media profile database 165. The example data table 600 of the illustrated example of FIG. 6 includes a media identifier column 610, a media time range column 620, and a media keyword(s) column 630. The media identifier column 610 identifies media (e.g., a television show, a movie). In the illustrated example, television shows aired via a broadcast television system are identified. However, any other type of media may additionally or alternatively be used. The example media time ranges of the example media time range column 620 are used by the example central facility 160 to determine whether media-exposure social media messages should be requested in association with a media presentation. In some examples, the media time ranges are repeated time ranges in that the media is expected to air periodically (e.g., once a week, once a month, every day, on weekdays, etc.). However, any other approach to identifying when media is expected to air, periodic and/or a-periodic, may additionally or alternatively be used.

The example media keywords of the example media keyword(s) column 630 are used when querying the social media server 110 to retrieve social media messages that are media-exposure social media messages that are associated with particular media (e.g., the media identified by the media identifier column 610). In the illustrated example, the media keywords are represented using a text string, with various keywords and/or phrases separated by semicolons. However, any other approach to storing the media keywords may additionally or alternatively be used.

The example data table 600 of the illustrated example of FIG. 6 includes five example rows 650, 660, 670, 680, 1090. The first example row 650 identifies that the media “SCANDAL” has a time range between 8 PM and 9 PM on Thursdays, and is identifiable using the keywords “SCANDAL ON STATION 2; FITZ; CYRUS; MELLIE; #SCANDAL.” The second example row 660 identifies that the media “GOTHAM” has a time range between 7 PM and 8 PM on Thursdays, and is identifiable using the media keywords “GOTHAM ON STATION 7; BRUCE WAYNE; BATMAN; GORDON; #GOTHAM.” The third example row 670 identifies that the media “COLLEGE FOOTBALL GAME 122” has a time range between 7 PM and 10 PM on Thursday, Nov. 20, 2014, and is identifiable using the media keywords “COLLEGE FOOTBALL ON THURSDAY; CATS; DOGS; #CATSVERSUSDOGS.” The fourth example row 680 identifies that the media “GREY'S ANATOMY” has a time range between 7 PM and 8 PM on Thursdays, and is identifiable using the media keywords “GREY'S ANATOMY ON STATION 2; MAGGIE; RICHARD; #GREYSANATOMY.” The fifth example row 690 identifies that the media “GRACEPOINT” has a time range between 8 PM and 9 PM on Thursdays, and is identifiable using the media keywords “GRACEPOINT ON STATION 4; DANNY; BETH; CHLOE; #GRACEPOINT.”

FIG. 7 is a flowchart representative of example machine-readable instructions 700 that may be executed by the example social media server 110 of FIG. 1 to reply to a request for social media message impression data and demographic information associated with the impression data. The example instructions 700 of the illustrated example of FIG. 7 begin when the example query responder 142 of the example social media server 110 of FIG. 1 receives a request for social media impression data and demographic information associated therewith from the query transmitter 175 of the example central facility 160 of FIG. 1. (Block 710). In the illustrated example, the example query includes a request that all social media messages and demographic data associated with impressions of the social media messages, where the social media message contains media keywords and the impressions occurred between a first time and a second time, be presented to the query transmitter 175. However, any other approach to querying the social media server 110 may additionally or alternatively be used.

In the illustrated example, the query is received via the network 145. However, the query may be received in any other fashion. Moreover, the example query of the illustrated example is received as the results are being requested. That is, the example query transmitter 175 expects an immediate response to the query. However, the query may be received ahead of time, and the example query responder 142 may await an appropriate time to respond to the query. For example, the example query transmitter 175 may, at the beginning of a media presentation, request all social media messages and demographic data associated with the media during a presentation time of the media (e.g., 7 PM to 8 PM) in 5 minute increments. In such an example, the example query responder 142 may provide the social media messages and demographic data associated with impressions of those social media messages every 5 minutes. Additionally or alternatively, the example query responder 142 may wait until the end of the media presentation (e.g., 8 PM), and then provide results for each 5 minute increment of the media presentation.

The example exposure identifier identifies a message having at least one impression between the first time and the second time identified in the query. (Block 720). In the illustrated example, timestamps of impression records stored in the social message exposure database 134 are compared to the first and second times identified in the query to determine whether the exposure is responsive to the query. The exposure identifier 140 then identifies whether the message includes the media keywords. (Block 730). In the illustrated example, the media keywords are text strings that are associated with particular media of interest. An example table 600 including example media keywords is shown in the illustrated example of FIG. 6. In the illustrated example, the exposure identifier 140 uses regular expressions to determine whether the social media message includes the media keywords. However, any other approach to identifying whether keywords are present in a social media message may additionally or alternatively be used.

If the media keywords are not present in the social media message (Block 730), the exposure identifier 140 determines whether additional messages having at least one impression between the first and second times exists. (Block 760). If such messages exist, the exposure identifier 140 identifies those messages (Block 720), and determines whether those messages include the media keywords (Block 730).

If the identified social media message includes the media keywords (Block 730), the example demographic aggregator 136 identifies a list of users associated with impressions between the first time and the second time. (Block 740). Using the identified list of users, the example demographic aggregator 136 retrieves demographics associated with those users from the user demographic database 125. The retrieved demographic information is summarized by the example demographic aggregator 136. (Block 750). In the illustrated example, the demographic aggregator 136 summarizes the demographic information by identifying a percentage of the users within the list of users that exhibit a particular demographic factor. For example, the example demographic aggregator 136 identifies a number of users from the list of users that are male. Example aggregated demographics are shown in the example data table 800 of the illustrated example of FIG. 8.

The exposure identifier 140 then determines whether additional messages having at least one impression between the first time and the second time exist. (Block 760). While in the illustrated example messages having at least one impression between the first time and the second time are identified, any other threshold number of messages may be identified. For example, messages having a minimum of one hundred impressions between the first time and the second time. Using a minimum threshold is advantageous because it reduces the likelihood that any personally identifiable information may be provided by the social media server 110. If additional messages exist, control proceeds to block 720 where the messages are identified in the manner described above. The example process of blocks 720-760 continues until no additional messages are identified (e.g., a “no” result breaks from block 760 to block 770). If no additional messages are identified, the example query responder 142 provides the social media messages and demographic data associated with impressions of those social media messages to the query transmitter 175. (Block 770). The example query responder 142 then awaits further requests for social media impression data and demographics associated therewith. (Block 710).

FIG. 8 is an example data table 800 representing example social media message impression data and demographic information associated with the impression data that may be supplied to the query transmitter 175 of the example central facility 160 of FIG. 1 by the social media server 110 of FIG. 1.

The example data table 800 of the illustrated example of FIG. 8 includes a message identifier column 805, an impression time range column 810, a message column 815, an impression count column 820, an age between twenty and twenty-nine column 825, an age between thirty and thirty-nine column 830, an age between forty and forty-nine column 835, a male column 840, and a female column 845.

The example message identifier column 805 indicates a message identifier of the social media message. The message identifier is useful to the example central facility 160 if, for example, the example sentiment estimator 180 has previously estimated the sentiment score for the identified message. Reusing previously identified sentiment scores reduces the amount of processing requirements of the central facility 160. The example impression time range column 810 identifies a time range within which the impressions identified by the impression count column 820 were identified. The example message column 815 includes the social media message identified by the message identifier 805. Including the social media message enables the sentiment estimator 180 to calculate a sentiment score for the social media message (if that score had not been previously calculated). The example impression count column 820 identifies a number of impressions that occurred within the time range identified by the impression time range column 810.

The example age between twenty and twenty-nine column 825, the example age between thirty and thirty-nine column 830, the example age between forty and forty-nine column 835, the example male column 840, and the example female column 845 identify respective percentages of the impressions that are attributable to the demographic segments identified by the respective column. While, in the illustrated example, age and gender demographics are shown, any other demographic factor may additionally or alternatively be used such as, for example, race, geographic location, income, etc. Moreover, in some examples, instead of identifying percentages, the example age between twenty and twenty-nine column 825, the example age between thirty and thirty-nine column 830, the example age between forty and forty-nine column 835, the example male column 840, and the example female column 845 identify a count of the number of impressions associated with the demographic segment identified by the respective column.

The example data table 800 includes four example rows corresponding to two impression time ranges. A first example row 850 indicates that message ID 0001 received 22,000 impressions between 8:15 PM and 8:20 PM. Of those impressions identified in the first example row 850, 18% were attributable to users between the age of twenty and twenty-nine, 20% were attributable to users between the ages of thirty and thirty-nine, 16% were attributable to users between the ages of forty and forty-nine, 40% were attributable to male users, and 60% were attributable to female users. A second example row 855 indicates that message ID 0002 received 10,000 impressions within the same time range as message ID 0001 (e.g., between 8:15 PM and 8:20 PM). Of those impressions identified in the second example row 855, 30% were attributable to users between the age of twenty and twenty-nine, 18% were attributable to users between the ages of thirty and thirty-nine, 13% were attributable to users between the ages of forty and forty-nine, 70% were attributable to male users, and 30% were attributable to female users.

A third example row 860 indicates that message ID 0001 received 18,000 impressions between 8:20 PM and 8:25 PM. Of those impressions identified in the third example row 660, 15% were attributable to users between the age of twenty and twenty-nine, 20% were attributable to users between the ages of thirty and thirty-nine, 13% were attributable to users between the ages of forty and forty-nine, 20% were attributable to male users, and 80% were attributable to female users. A fourth example row 865 indicates that message ID 0002 received 3,000 impressions within the same time range as message ID 0001 (e.g., between 8:20 PM and 8:25 PM). Of those impressions identified in the fourth example row 860, 22% were attributable to users between the age of twenty and twenty-nine, 16% were attributable to users between the ages of thirty and thirty-nine, 65% were attributable to users between the ages of forty and forty-nine, 65% were attributable to male users, and 45% were attributable to female users.

FIG. 9 represents an example data table 900 that may be stored by the example central facility 160 of FIG. 1 to associate sentiment keywords with a sentiment modifier. The example data table 900 of the illustrated example of FIG. 9 is stored in the example sentiment score database 181 of the example central facility 160 of FIG. 1. The example data table 900 of the illustrated example of FIG. 9 includes a sentiment keyword column 910 and a sentiment modifier column 920. The example sentiment keyword column 910 identifies keywords which, when present in a media-exposure social media message, result in a positively and/or negatively valenced message. The example sentiment modifier column 920 identifies a sentiment modifier (e.g., a numeric value) associated with the keyword identified by the sentiment keyword column 910.

The example data table 900 of the illustrated example of FIG. 9 includes five example rows 950, 960, 970, 980, 990 representing five sentiment keywords and their associated sentiment modifier(s). The first example row 950 indicates that the keyword “crazy” is associated with a sentiment modifier of “+.4.” The second example row 960 indicates that the keyword “average” is associated with a sentiment modifier of “−.2.” The third example row 970 indicates that the keyword “exciting” is associated with a sentiment modifier of “+.7.” The fourth example row 980 indicates that the keyword “boring” is associated with a sentiment modifier of “−.7.” The fifth example row indicates that the keyword “funny” is associated with a sentiment modifier of “+.5.”

FIG. 10 is a flowchart representative of example machine-readable instructions 1000 that may be executed to calculate a sentiment score of a social media message based on the presence of sentiment keywords in the social media message. The example instructions 1000 begin when the sentiment estimator 180 identifies a media-exposure social media message for which a sentiment score is to be computed. (Block 1010). The example sentiment estimator 180 identifies the media-exposure social media message when, for example, the media-exposure social media message is supplied by the query responder 142 of the example social media server 110 in response to a request by the query transmitter 175 of the central facility 160. However, in some examples, the example media-exposure social media message is processed upon generation of a report. That is, the media-exposure social media message may be processed upon receipt, or may additionally or alternatively be stored (e.g., buffered, cached, etc.) for later processing.

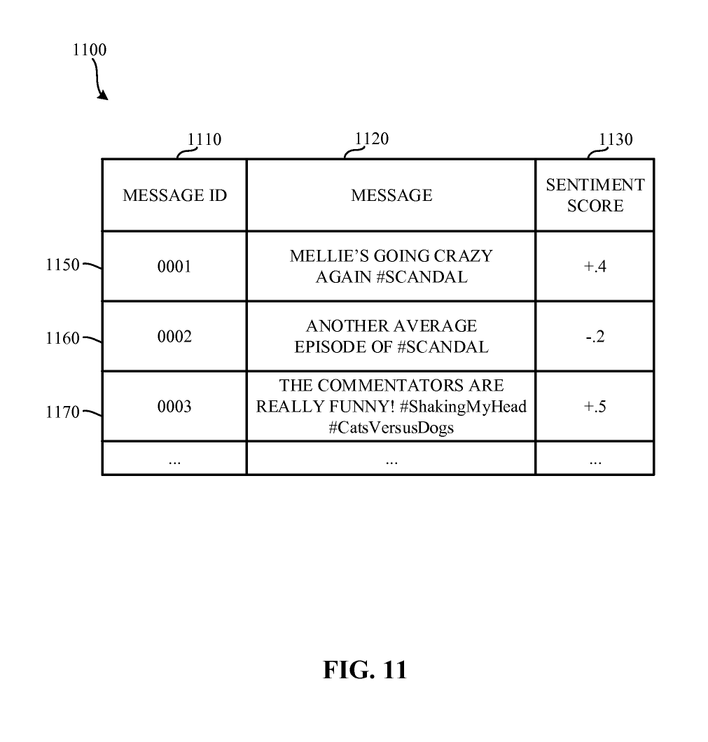

In some examples, the media-exposure social media message may be a message that had previously been processed by the sentiment estimator 180. For example, a sentiment score for the media-exposure social media message may have been calculated when the media-exposure social media message was received in association with a first time period (e.g., a time period at a beginning of a media presentation). As such, the sentiment estimator 180 may identify that the media-exposure social media message was received in association with a second, later, time period (e.g., a time period at an end of a media presentation). To account for such a scenario, the example sentiment estimator 180 determines whether a sentiment score has previously been estimated for the identified media-exposure social media message. (Block 1015). Identifying whether the sentiment score has previously been estimated reduces processing requirements of the central facility 160, because duplicative sentiment scores are not estimated. In the illustrated example, the example sentiment estimator 180 determines whether the sentiment score has previously been estimated by inspecting a sentiment score data table such as, for example, the example data table 1100 of FIG. 11 using the message identifier.

If the sentiment score has been estimated (Block 1015), the example sentiment estimator 180 determines whether there are additional media-exposure social media messages to process. (Block 1080). If there are additional messages to process (Block 1080), the example sentiment estimator 180 identifies the messages (Block 1010), and determines whether the sentiment score has been estimated for the identified message. (Block 1015).

If the sentiment score has not been estimated for the identified message (Block 1015), the example sentiment estimator initializes a sentiment score for the identified message to zero. (Block 1020). The example sentiment estimator 180 selects a sentiment keyword and an associated sentiment modifier from the example sentiment score database 181. (Block 1030). The example sentiment score estimator 180 parses the media-exposure social media message to identify the presence of the sentiment keyword. (Block 1040). In the illustrated example, the presence of the sentiment keyword is identified by the use of regular expressions. However, any other approach to identifying the presence of the sentiment keyword may additionally or alternatively be used.

If the sentiment keyword is present in the media-exposure social media message (Block 1050), the example sentiment estimator 180 adjusts the sentiment score based on the sentiment modifier associated with the identified sentiment keyword. (Block 1060). In the illustrated example, the sentiment score is modified by adding the sentiment modifier associated with the identified sentiment keyword to the current sentiment score. However, any other approach to modifying the sentiment score may additionally or alternatively be used. For example, sentiment modifiers associated with identified keywords may be aggregated (e.g., stored, buffered, cached, etc.) and then averaged to estimate the sentiment score. If the sentiment keyword is not present (Block 1050) and/or once the sentiment score has been modified based on the identified sentiment keyword, the example sentiment estimator 180 identifies whether there are additional sentiment keywords to be tested. (Block 1070). Additional keywords are identified when, for example, the example sentiment estimator 180 has not yet determined whether the keyword (e.g., a keyword from the example data table 900 of FIG. 9) is present in the media-exposure social media message. If there are additional sentiment keywords to be tested (Block 1070), the sentiment estimator 180 retrieves the sentiment keyword and its associated sentiment modifier. (Block 1030). If there are no additional sentiment keywords to test (Block 1070), the example sentiment estimator 180 stores the sentiment score for the media-exposure social media message in the sentiment score database 181. (Block 1075). In the illustrated example, the estimated sentiment score is stored in the example sentiment score database 181 in a format such as, for example, the example sentiment score data table 1100 of FIG. 11. However, any other approach and/or format to storing the estimated sentiment score may additionally or alternatively be used.

The example sentiment estimator then determines whether there are additional media-exposure social media messages to be processed. (Block 1080). If additional messages are to be processed (Block 1080), the additional message(s) are identified (Block 1010) and processed.

FIG. 11 represents an example sentiment score data table 1100 that may be stored by the audience measurement entity of FIG. 1 representing example calculations of a sentiment score. The example sentiment score data table 1100 of the illustrated example of FIG. 11 includes a message ID column 1110, a message column 1120, and a sentiment score column 1130. The example message ID column 1110 stores an identifier (e.g., a serial number, a hash, etc.) of the message stored in the example message column 1120. The example sentiment score column 1130 identifies the sentiment score for the message identified in the message ID column 1110 and shown in the example message column 1120.

In the illustrated example of FIG. 11, the example sentiment score data table includes three example rows 1150, 1160, 1170. The first example row 1150 indicates that the message having the identifier “0001” and the text of “MELLIE'S GONG CRAZY AGAIN #SCANDAL” has an estimated sentiment score of “+.4.” In the illustrated example, the sentiment score of the first example row 1150 is “+.4” because the message contained the sentiment keyword “CRAZY”, which is associated with a sentiment modifier of “+.4.” The second example row 1160 indicates that the message having the identifier of “0002” and the text of “ANOTHER AVERAGE EPISODE OF #SCANDAL” has an estimated sentiment score of “−.2.” The third example row 1170 indicates that the message having the identifier of “0003” and the text of “THE COMMENTATORS ARE REALLY FUNNY! #ShakingMyHead #CatsVersusDogs” has an estimated sentiment score of “+.5”

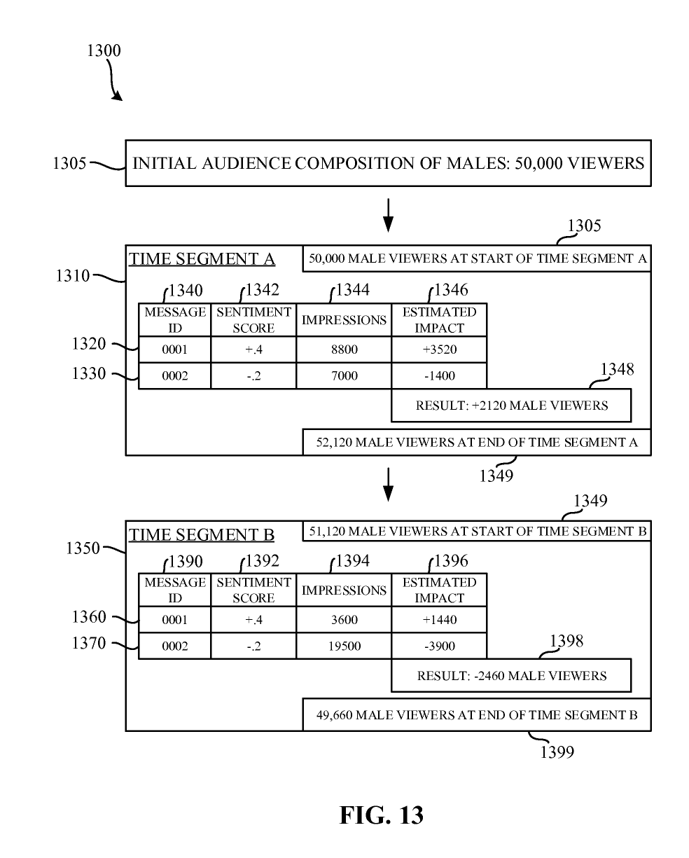

FIG. 12 is a flowchart representative of example machine readable instructions 1200 that may be executed to estimate a size of a demographic segment viewing media based on a sentiment(s) conveyed in social media message(s) presented to users of the demographic segment. FIG. 13 is an example calculation diagram illustrating an example calculation 1300 performed in accordance with the example machine readable instructions 1200 of FIG. 12.

The example instructions 1200 of FIG. 12 begin when the example query generator 170 identifies media for which a report is desired. In the illustrated example, the media is identified based on its presence of a media profile in the example media profile database 165 (e.g., in the example data table 600 of the illustrated example of FIG. 6). In the illustrated example, the media is identified automatically. However, in some examples, the media is identified in response to a user request.

The example query generator 170 performs a lookup in the example media profile database 165 of the media keywords associated with the identified media. (Block 1210). The query generator 170 then identifies a time segment of interest. (Block 1220). The example calculation diagram 1300 of FIG. 13 identifies two time segments: a first segment 1310 and a second segment 1350. In the illustrated example, the time segments represent five minute increments during a presentation of the identified media. However, any other duration and/or length of segments may additionally or alternatively be used.

The example query transmitter 175 then queries the query responder 142 to request social media messages having impressions during the time segment that include the identified media keyword(s) and demographic information associated therewith. (Block 1225). The example audience demographic estimator 185 identifies an initial size of a demographic segment at the beginning of the time segment (e.g., a number of persons within the demographic segment that are watching the media). (Block 1230). In the illustrated example, the initial size of the demographic segment is estimated based on prior audiences of the media. However, the size of the demographic segment may be identified in any other fashion. For example, the example audience demographic estimator 185 may consult a separate media monitoring system of the AME 155 to identify an estimated audience of the media. Referring to FIG. 13, the example audience demographic estimator 185 identifies that the initial size of the male demographic segment includes 50,000 viewers (item 1305).

The example sentiment estimator 180 then calculates a sentiment score for a media-exposure social media message identified in the results of the query. (Block 1235). In the illustrated example, the example sentiment estimator 180 calculates the sentiment score in accordance with the example instructions 1000 of FIG. 10. The sentiment score for the media-exposure social media message is then applied to the impressions attributable to the demographic segment to form an estimated impact of the media-exposure social media message on the demographic segment. (Block 1240). In the illustrated example, the sentiment score is multiplied by the number of impressions to calculate the estimated impact. However, any other approach to calculating the estimated impact may additionally or alternatively be used. Referring to the example calculation of FIG. 13, within the first time segment (Block 1310), the first message (row 1320) has a sentiment score of “+.4” and resulted in 8,800 identified impressions of the corresponding media-exposure social media message. In the illustrated example of FIG. 13, the example sentiment score (+.4) is multiplied by the identified impressions (8,800), to result in an estimated impact of 3,520 additional viewers that are part of the male demographic segment.

The example sentiment estimator 180 identifies if additional media-exposure social media message(s) were identified by the results of the query. (Block 1245). If additional messages were presented, the example sentiment estimator 180 calculates the sentiment score for the identified additional message (Block 1235), and the example audience demographic estimator 185 estimates the impact of the media-exposure social media message (Block 1240). Referring again to FIG. 13, the second message (row 1330) has a sentiment score of −.2 and resulted in 7,000 identified impressions of the corresponding media-exposure social media message. In the illustrated example of FIG. 13, the example sentiment score (−.2) is multiplied by the identified impressions (7,000), to result in an estimated impact of 1,400 fewer viewers that are part of the male demographic segment.

Once the example audience demographic estimator 185 identifies that no additional media-exposure social media message(s) were identified by the results of the query (Block 1245), the example reporter 190 summarizes the estimated impacts of the media-exposure social media messages on the demographic segment. (Block 1250). In the illustrated example, the estimated impacts are summarized by adding the estimated impacts together. However, any other approach to summarizing the estimated impacts may additionally or alternatively be used such as, for example, determining a mean, determining a median, etc. In the illustrated example of FIG. 13, the estimated impact of the first message of the first time segment (row 1320) (+3520 viewers) is added with the estimated impact of the second message of the first time segment (row 1330) (−1400 viewers) to create a combined estimated impact of an additional 2120 male viewers. (Block 1348). The example audience demographic estimator 185 calculates a new estimated size of the demographic segment using the combined estimated impact. (Block 1255). In the illustrated example, the estimated impact (+2120 male viewers, block 1348) is added to the initial size of the demographic segment (50,000 male viewers, corresponding to block 1305), to form an estimated size of the demographic segment at the end of the time segment (52,120 male viewers, block 1349).

The example audience demographic estimator 185 determines whether there are other demographic segments to have an estimated size calculated. (Block 1260) While a calculation illustrating calculation of an estimated size of the male demographic segment is shown in the illustrated example of FIG. 13, sizes of additional and/or alternative demographic segments may be calculated. For example, an estimate of the female demographic segment may be calculated, an estimate of viewers within a particular age group may be calculated, etc. If a size(s) of an additional demographic segment(s) is to be estimated, control proceeds to block 1230 where the example audience demographic estimator 185 identifies the initial size of the demographic segment of interest, and proceeds to calculate the estimated impact of the media-exposure social media messages on that demographic segment.

If no additional demographic segments are to be processed (Block 1260), the example query generator 170 determines whether an additional time segment is to be processed. (Block 1265). The example query generator 170 determines whether an additional time segment is to be processed by determining if there is a subsequent time segment that is still within the media presentation time range of the media. If there are additional time segment(s) to be processed, control proceeds to block 1220, where the example query transmitter 170 identifies the time segment. The example calculation diagram 1300 of FIG. 13 illustrates an example second time segment 1350. The example second time segment 1350 represents a time segment that occurs sequentially after the first time segment 1210. As such, the second example time segment 1250 identifies that at the start of the second time segment, the size of the male demographic segment includes 51,120 male viewers (block 1349).

In the illustrated example of FIG. 13, the first media-exposure social media message (row 1360) received 3600 impressions. The first media-exposure social media message of the second time segment 1350 (row 1360) corresponds to the same message as the first media-exposure social media message of the first time segment 1310 (row 1320), as the message identifiers of each of the first and second media-exposure social media messages match. As such, when calculating the sentiment score, the example sentiment estimator 180 performs a lookup using the message identifier from the sentiment score database 181, rather than re-processing a text of the media-exposure social media message. Within the second time segment 1350, the example first media-exposure social media message (row 1360) received 3600 impressions, resulting in an estimated impact of 1440 additional viewers. The second media-exposure social media message of the second time segment 1350 (row 1370) indicates that the second media-exposure social media message received 19,500 impressions. As a result, the example audience demographic estimator 185 computes an estimated impact of 3900 fewer viewers. The estimated impacts of the first and second media-exposure social media messages (row 1360, row 1370) of the second time segment 1350 are summarized to determine that the size of the male demographic segment was estimated to have decreased by 2460 viewers. At the end of the second time segment 1350, the total size of the male demographic segment is estimated to be 49,660 male viewers.

Once the additional time segment(s) are processed (Block 1265), the example query transmitter 170 identifies whether there is additional media to be processed. (Block 1270). The example query transmitter 170 consults the example media profile database 165 storing, for example, the example media profile data table 600 of FIG. 6 to identify whether there is other media to be processed. If additional media is to be processed, control proceeds to block 1205, where the media is identified and subsequently processed. In some examples, the example media is processed in response to a user request. In such an example, the request may identify a single media (e.g., please provide a demographic report for the television show “SCANDAL”), and further processing of other media may not be required. If no additional media is to be processed (Block 1270), the example reporter 190 prepares a report (e.g., the report 195 of FIG. 1) identifying the sizes of the demographic segment(s) over the computed time segments. (Block 1275). In the illustrated example, a single report is generated representing sizes of demographic segments that are viewing the identified media at different times. However, any other approach to generating a report may additionally or alternatively be used. Moreover, in some examples, multiple reports may be generated corresponding to, for example, different media, different demographic segments, etc. Once the example reporter 190 completes generation of the report (Block 1275), the example process of FIG. 12 terminates. In some examples, the example query generator 170 waits until a subsequent report is to be generated, and then re-starts the example process of FIG. 12.

FIG. 14 is a block diagram of example hardware structured to execute the instructions of FIGS. 4 and/or 7 to implement the example social media server 110 of FIG. 1. The social media server 110 can be, for example, a server, a personal computer, an Internet appliance, and/or any other type of computing device.

The server 110 of the illustrated example includes a processor 1412. The processor 1412 of the illustrated example is a semiconductor-based hardware device. For example, the processor 1412 can be implemented by one or more integrated circuits, logic circuits, microprocessors or controllers from any desired family or manufacturer.

The processor 1412 of the illustrated example includes a local memory 1413 (e.g., a cache), and executes instructions to implement the example social media registrar 120, the example demographic aggregator 136, and/or the example exposure identifier 140. The processor 1412 of the illustrated example is in communication with a main memory including a volatile memory 1414 and a non-volatile memory 1416 via a bus 1418. The volatile memory 1414 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1416 may be implemented by flash memory and/or any other desired type of memory device. Access to the main memory 1414, 1416 is controlled by a memory controller.

The social media server 110 of the illustrated example also includes an interface circuit 1420. The interface circuit 1420 may be implemented by any type of interface standard, such as an Ethernet interface, a universal serial bus (USB), and/or a PCI express interface.

In the illustrated example, one or more input devices 1422 are connected to the interface circuit 1420. The input device(s) 1422 permit(s) a user to enter data and commands into the processor 1412. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1424 are also connected to the interface circuit 1420 of the illustrated example. The output devices 1424 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 1420 of the illustrated example, thus, typically includes a graphics driver card, a graphics driver chip or a graphics driver processor.

The interface circuit 1420 of the illustrated example also includes a communication device such as a transmitter, a receiver, a transceiver, a modem and/or network interface card to facilitate exchange of data with external machines (e.g., computing devices of any kind) via a network 1426 (e.g., an Ethernet connection, a digital subscriber line (DSL), a telephone line, coaxial cable, a cellular telephone system, etc.). The example interface circuit 1420 implements the example social message interface 130 and/or the example query responder 142.

The social media server 110 of the illustrated example also includes one or more mass storage devices 1428 for storing software and/or data. Examples of such mass storage devices 1428 include floppy disk drives, hard drive disks, compact disk drives, Blu-ray disk drives, RAID systems, and digital versatile disk (DVD) drives. The example mass storage 1428 implements the example user demographic database 125, the example social message database 132, and/or the example social message exposure database 134.

The coded instructions 1432 of FIGS. 4 and/or 7 may be stored in the mass storage device 1428, in the volatile memory 1414, in the non-volatile memory 1416, and/or on a removable tangible computer readable storage medium such as a CD or DVD.

FIG. 15 is a block diagram of example hardware structured to execute the instructions of FIGS. 10 and/or 12 to implement the example central facility 160 of FIG. 1. The central facility 160 can be, for example, a server, a personal computer, an Internet appliance, and/or any other type of computing device.

The central facility 160 of the illustrated example includes a processor 1512. The processor 1512 of the illustrated example is a semiconductor based hardware device. For example, the processor 1512 can be implemented by one or more integrated circuits, logic circuits, microprocessors, or controllers from any desired family or manufacturer.

The processor 1512 of the illustrated example includes a local memory 1513 (e.g., a cache), and executes instructions to implement the example query generator 170, the example sentiment estimator 180, the example audience demographic estimator 185, and/or the example reporter 190. The processor 1512 of the illustrated example is in communication with a main memory including a volatile memory 1514 and a non-volatile memory 1516 via a bus 1518. The volatile memory 1514 may be implemented by Synchronous Dynamic Random Access Memory (SDRAM), Dynamic Random Access Memory (DRAM), RAMBUS Dynamic Random Access Memory (RDRAM), and/or any other type of random access memory device. The non-volatile memory 1516 may be implemented by flash memory and/or any other desired type of memory device. Access to the main memory 1514, 1516 is controlled by a memory controller.

The central facility 160 of the illustrated example also includes an interface circuit 1520. The interface circuit 1520 may be implemented by any type of interface standard, such as an Ethernet interface, a universal serial bus (USB), and/or a PCI express interface.

In the illustrated example, one or more input devices 1522 are connected to the interface circuit 1520. The input device(s) 1522 permit(s) a user to enter data and commands into the processor 1512. The input device(s) can be implemented by, for example, an audio sensor, a microphone, a camera (still or video), a keyboard, a button, a mouse, a touchscreen, a track-pad, a trackball, isopoint, and/or a voice recognition system.

One or more output devices 1524 are also connected to the interface circuit 1520 of the illustrated example. The output devices 1524 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 1520 of the illustrated example, thus, typically includes a graphics driver card, a graphics driver chip or a graphics driver processor.

The interface circuit 1520 of the illustrated example also includes a communication device such as a transmitter, a receiver, a transceiver, a modem and/or network interface card to facilitate exchange of data with external machines (e.g., computing devices of any kind) via a network 1526 (e.g., an Ethernet connection, a digital subscriber line (DSL), a telephone line, coaxial cable, a cellular telephone system, etc.). The example interface circuit 1520 implements the example query transmitter 175.

The central facility 160 of the illustrated example also includes one or more mass storage devices 1528 for storing software and/or data. Examples of such mass storage devices 1528 include floppy disk drives, hard drive disks, compact disk drives, Blu-ray disk drives, RAID systems, and digital versatile disk (DVD) drives. The example mass storage 1528 implements the example media profile database 165 and/or the example sentiment score database 181.

The coded instructions 1532 of FIGS. 10 and/or 12 may be stored in the mass storage device 1528, in the volatile memory 1514, in the non-volatile memory 1516, and/or on a removable tangible computer readable storage medium such as a CD or DVD.

From the foregoing, it will be appreciated that the above-disclosed methods, apparatus, and articles of manufacture enable estimation of a size of a demographic segment within an audience of a media presentation. Examples disclosed herein operate based on social media messages related to media (e.g., media-exposure social media messages) and demographic information associated with impressions thereof to estimate a size of a demographic segment.

In traditional audience measurement systems, audience measurement servers collected data from many different metering devices (e.g., ten thousand metering devices, one hundred thousand metering devices, etc.). The large number of metering devices resulted in many different sources of media monitoring data to be accessed and/or collected. Examples disclosed herein collect media monitoring data from a small number of social media servers (e.g., one social media server, five social media servers, etc.). Using a single point where data is collected reduces the amount of bandwidth required for operating the central facility. For example, instead of collecting data from ten thousand different devices (which may include a significant amount of communications overhead), data may instead be collected from a single social media server. Moreover, because data was traditionally collected from many different metering devices, there existed a significant likelihood that not all data would be collected in a timely fashion. As such, prior media exposure reports were typically delayed until a statistically significant portion of the metering data could be collected from the metering devices. By collecting information indicating exposure to media-exposure social media messages and demographic information associated therewith, such timing and/or phasing issues are alleviated. Moreover, because monitoring data is received from a limited number of sources (e.g., the social media server), the reduced overhead of processing and/or storing the monitoring data reduces memory and/or processing requirements of the central facility and/or audience measurement entity.

Although certain example methods, apparatus, and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method to estimate demographics for an audience of a media event, the method comprising:
calculating, with a processor, a sentiment score for a media-exposure social media message received from a social media server, the media-exposure social media message identified based on a media keyword;
retrieving demographic information associated with users who viewed the media-exposure social media message; and
calculating an estimated impact on a size of a demographic segment of viewers using the sentiment score and the demographic information.

2. The method as defined in claim 1, wherein calculating the sentiment score further comprises:
parsing a text of the media-exposure social media message to identify a keyword;
associating the keyword with a value; and
summing the value for a plurality of keywords identified in the text of the media-exposure social media message.

3. The method as defined in claim 1, further comprising identifying the media-exposure social media message by:
identifying a reference to the media event in a text of the media-exposure social media message; and
determining whether a characteristic of the media-exposure social media message satisfies a rule associated with the media event.

4. The method as defined in claim 3, wherein the rule associated with the media event is a broadcast time of the media event.

5. The method as defined in claim 3, further comprising calculating the sentiment score for the media-exposure social media message in response to determining that the characteristic of the media-exposure social media message satisfies the rule associated with the media event.

6. The method as defined in claim 1, wherein determining the demographics associated with users of social media exposed to the media-exposure social media message comprises:
identifying an impression associated with the social media message, the impression corresponding with exposure to the social media message;
identifying a user identifier associated with the impression; and
determining demographics associated with the user identifier.

7. The method as defined in claim 1, wherein the sentiment score is a first sentiment score, the media-exposure social media message is a first media-exposure social media message, the estimated impact is a first estimated impact, and further comprising:
calculating a sentiment score associated with a second media-exposure social media message; and
calculating an second estimated impact on the size of the demographic segment of viewers using the second sentiment score and the demographic information; and
calculating a total estimated impact on the size of the demographic segment of viewers using the first estimated impact and the second estimated impact.

8. An apparatus to estimate demographics for an audience, the apparatus comprising:
a query transmitter to transmit, to a social media server, a query requesting a media-exposure social media message and demographic information associated with impressions of the media-exposure social media message, the media-exposure social media message associated with media;
a sentiment estimator to calculate a sentiment score for the media-exposure social media message; and
an audience demographic estimator to calculate an estimated impact on a size of a demographic segment based on the sentiment score and the demographic information.

9. The apparatus as defined in claim 8, wherein the sentiment estimator is to parse a text of the media-exposure social media message to identify a presence of a sentiment keyword within the text of the media-exposure social media message.

10. The apparatus as defined in claim 8, further comprising a query generator to generate the query based on a media profile identifying when the media is presented.

11. The apparatus as defined in claim 8, further comprising a query generator to generate the query based on a media keyword associated with the media.

12. The apparatus as defined in claim 8, wherein the sentiment score is a first sentiment score, the media-exposure social media message is a first media-exposure social media message, the demographic information is a first demographic information, the audience demographic estimator is further to calculate the estimated impact on the size of the demographic segment based on a second sentiment score associated with a second media-exposure social media message and second demographic information associated with the second media-exposure social media message.

13. The apparatus as defined in claim 8, further comprising a reporter to generate a report indicative of the size of the demographic segment.

14. A tangible machine readable storage medium comprising instructions which, when executed, cause a machine to at least:
calculate a sentiment score for a media-exposure social media message received from a social media server, the media-exposure social media message identified based on a media keyword;
retrieve demographic information associated with users who viewed the media-exposure social media message; and
calculate an estimated impact on a size of a demographic segment of viewers using the sentiment score and the demographic information.

15. The machine readable storage medium as defined in claim 14, further comprising instructions which, when executed, cause the machine to at least:
parse a text of the media-exposure social media message to identify a keyword;
associate the keyword with a value; and
sum the value for a plurality of keywords identified in the text of the media-exposure social media message.

16. The machine readable storage medium as defined in claim 14, further comprising instructions which, when executed, cause the machine to at least:
identify a reference to the media event in a text of the media-exposure social media message; and
determine whether a characteristic of the media-exposure social media message satisfies a rule associated with the media event.

17. The machine readable storage medium as defined in claim 16, wherein the rule associated with the media event is a broadcast time of the media event.

18. The machine readable storage medium as defined in claim 16, further comprising instructions which, when executed, cause the machine to calculate the sentiment score for the media-exposure social media message in response to determining that the characteristic of the media-exposure social media message satisfies the rule associated with the media event.

19. The machine readable storage medium as defined in claim 14, further comprising instructions which, when executed, cause the machine to at least:
identify an impression associated with the social media message, the impression corresponding with exposure to the social media message;
identify a user identifier associated with the impression; and
determine demographics associated with the user identifier.

20. The machine readable storage medium as defined in claim 14, wherein the sentiment score is a first sentiment score, the media-exposure social media message is a first media-exposure social media message, the estimated impact is a first estimated impact, and further comprising instructions which, when executed, cause the machine to at least:
calculate a sentiment score associated with a second media-exposure social media message; and
calculate an second estimated impact on the size of the demographic segment of viewers using the second sentiment score and the demographic information; and
calculate a total estimated impact on the size of the demographic segment of viewers using the first estimated impact and the second estimated impact.
